(19) United States
(12) Patent Application Publication
(10) Pub. No.: US 2012/0038238 A1
(43) Pub. Date: Feb. 16, 2012

(54) AC Generator for Vehicle

(75) Inventors: Yoshihisa Ishikawa, Ibaraki (JP); Kenji Miyata, Ibaraki (JP); Takayuki Koyama, Ibaraki (JP); Masahiko Honma, Ibaraki (JP)

(73) Assignee: Hitachi, Ltd., Chiyoda-ku, Tokyo (JP)

(21) Appl. No.: 13/201,887

(22) PCT Filed: Mar. 11, 2009
(86) PCT No.: PCT/JP2009/054681

§ 371 Date: Nov. 1, 2011

(51) Int. Cl. H02K 3/12; H02K 3/28

(52) U.S. Cl. 310/208

(57) ABSTRACT

A vehicular AC generator includes: a rotor (1) with a plurality of magnetic poles (113), assuming a shape for suppressing bias magnetism, and disposed along a circumferential direction, which includes a field winding (12); a stator (2) disposed so as to leave a gap between the rotor (1) and the stator (2); and a semiconductor element that rectifies an AC current induced at a stator coil (105) wound at the stator (2) as power is supplied to the field winding (112) at the rotor (1) so as to convert the AC current to a DC current, wherein: the stator (2) is formed by laminating electromagnetic steel plates; and a resistance value of the stator coil (105) wound at the stator (2) is set to a value equal to or less than a predetermined value.

### TECHNICAL FIELD

The present invention relates to a vehicular AC generator.

### BACKGROUND ART

Stator coils in vehicular AC generators are configured by adopting a distributed winding structure, a concentrated winding structure or the like of the known art. For instance, a winding structure in the known art includes a first three-phase connection coil achieved by connecting over three phases three stator coils that are wound at teeth of a stator core through short-pitch lap winding relative to the magnetic pole pitch assumed at a rotor, and a second three-phase winding coil achieved as is the first three-phase connection coil by connecting over three phases three stator coils that are wound at teeth each with an offset of π/3 (rad) in electric angle relative to one of the stator coils in the first three-phase connection coil through short-pitch lap winding (see, for instance, Patent Literature 1).
Patent literature 1: Japanese Laid Open Patent Publication No. H6-165422

### DISCLOSURE OF THE INVENTION

### Problems to be Solved by the Invention

In view of the recent issue of energy conservation, a further improvement in the efficiency of vehicular AC generators is pursued with increasing zeal. However, an improvement of about 70% in efficiency has been achieved at most through existing technologies and a more improvement cannot be achieved.

### Means for Solving the Problems

According to the 1st aspect of the present invention, a vehicular AC generator comprises: a rotor with a plurality of magnetic poles, assuming a shape for suppressing bias magnetism, and disposed along a circumferential direction, which includes a field winding; a stator disposed so as to leave a gap between the rotor and the stator; and a semiconductor element that rectifies an AC current induced at a stator coil wound at the stator as power is supplied to the field winding at the rotor so as to convert the AC current to a DC current, wherein: the stator is formed by laminating electromagnetic steel plates; and a resistance value of the stator coil wound at the stator is set to a value equal to or less than a predetermined value.

According to the 2nd aspect of the present invention, a vehicular AC generator comprises: a rotor with a plurality of magnetic poles, assuming a shape for suppressing bias magnetism and disposed along a circumferential direction, which includes a field winding; a stator disposed so as to leave a gap between the rotor and the stator; and a semiconductor element that rectifies an AC current induced at a stator coil wound at the stator as power is supplied to the field winding at the rotor so as to convert the AC current to a DC current, wherein: the stator is formed by laminating electromagnetic steel plates; and a stator ohmic loss manifesting under a half load is equal to or less than a predetermined value.

According to the 3rd aspect of the present invention, a vehicular AC generator comprises: a rotor with a plurality of magnetic poles, assuming a shape for suppressing bias magnetism and disposed along a circumferential direction, which includes a field winding; a stator disposed so as to leave a gap between the rotor and the stator and assuming a diameter equivalent to a diameter of a stator in a nominal Φ 139 vehicular AC generator; and a diode that rectifies an AC current induced at a stator coil wound at the stator as power is supplied to the field winding at the rotor so as to convert the AC current to a DC current, wherein: the stator is formed by laminating electromagnetic steel plates; and a stator ohmic loss is less than a sum of a rectification loss occurring at the diode, a mechanical loss and a field ohmic loss.

According to the 4th aspect of the present invention, a vehicular AC generator comprises: a rotor with a plurality of magnetic poles, assuming a shape for suppressing bias magnetism and disposed along a circumferential direction, which includes a field winding; a stator disposed so as to leave a gap between the rotor and the stator and assuming a diameter equivalent to a diameter of a stator in a nominal Φ 128 vehicular AC generator; and a diode that rectifies an AC current induced at a stator coil wound at the stator as power is supplied to the field winding at the rotor so as to convert the AC current to a DC current, wherein: the stator is formed by laminating electromagnetic steel plates; and a sum of a stator ohmic loss and an iron loss is less than a sum of a rectification loss occurring at the diode, a mechanical loss and a field ohmic loss.

According to the 5th aspect of the present invention, a vehicular AC generator comprises: a rotor with a plurality of magnetic poles, assuming a shape for suppressing bias magnetism and disposed along a circumferential direction, which includes a field winding; a stator disposed so as to leave a gap between the rotor and the stator; and a diode that rectifies an AC current induced at a stator coil wound at the stator as power is supplied to the field winding at the rotor, so as to convert the AC current to a DC current, wherein: the stator is formed by laminating electromagnetic steel plates with a thickness of 0.35 mm, which manifest a loss of 2 to 3 W/kg when a rotational frequency is 50 Hz and a magnetic flux density is 1.5 T; and a sum of a stator ohmic loss and iron loss is set equal to or less than a predetermined value so as to ensure that power generation efficiency of at least 76% is achieved under a half load.

According to the 6th aspect of the present invention, a vehicular AC generator comprises: a rotor with a plurality of magnetic poles, assuming a shape for suppressing bias magnetism and disposed along a circumferential direction, which includes a field winding; a stator disposed so as to leave a gap between the rotor and the stator; and a MOSFET that rectifies an AC current induced at a stator coil wound at the stator as power is supplied to the field winding at the rotor, so as to convert the AC current to a DC current, wherein: the stator is formed by laminating electromagnetic steel plates with a thickness of 0.35 mm, which manifest a loss of 2 to 3 W/kg when a rotational frequency is 50 Hz and a magnetic flux density is 1.5 T; and a sum of a stator ohmic loss and iron loss is set equal to or less than a predetermined value so as to ensure that power generation efficiency of at least 86% is achieved under a half load.

### Advantageous Effect of the Invention

According to the present invention, a further improvement is achieved in the efficiency of vehicular AC generators.

### BRIEF DESCRIPTION OF THE DRAWINGS

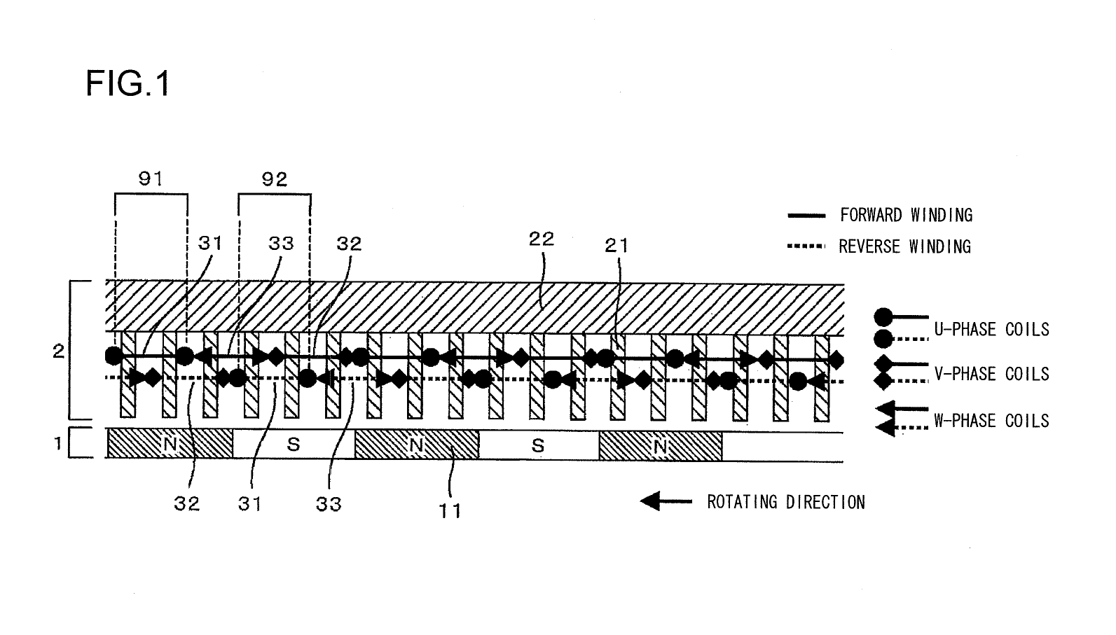

(FIG. 1) A conceptual diagram of the vehicular AC generator achieved in embodiment 1

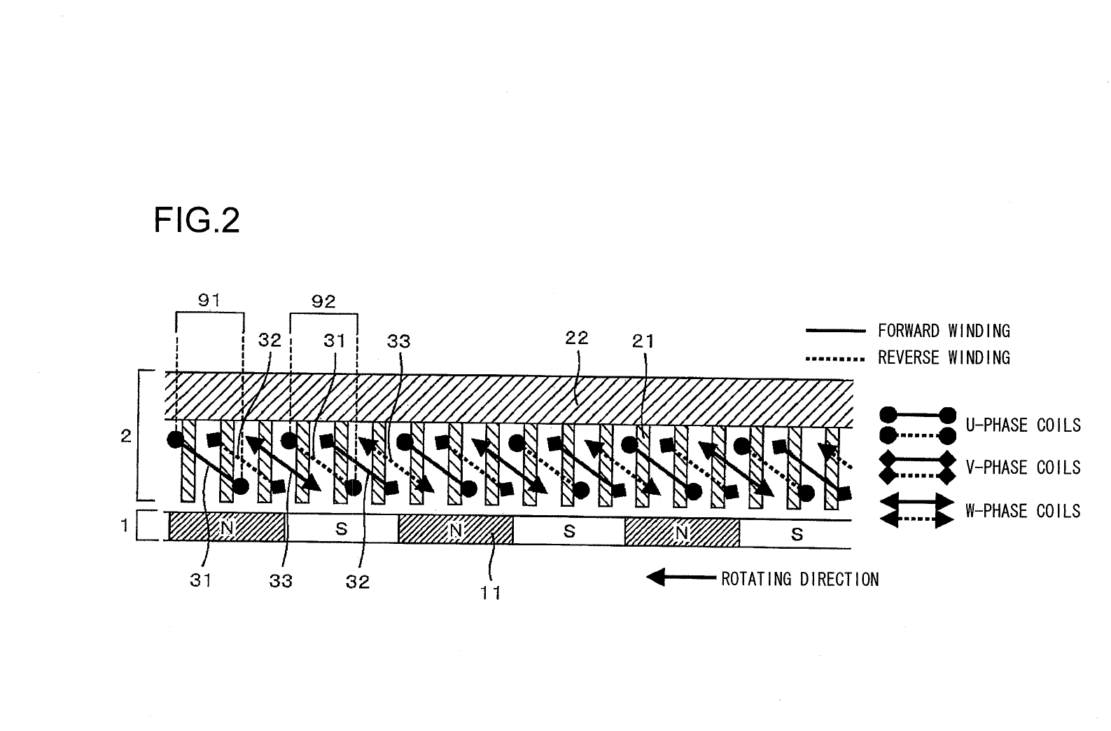

(FIG. 2) A conceptual diagram of the vehicular AC generator achieved in embodiment 2

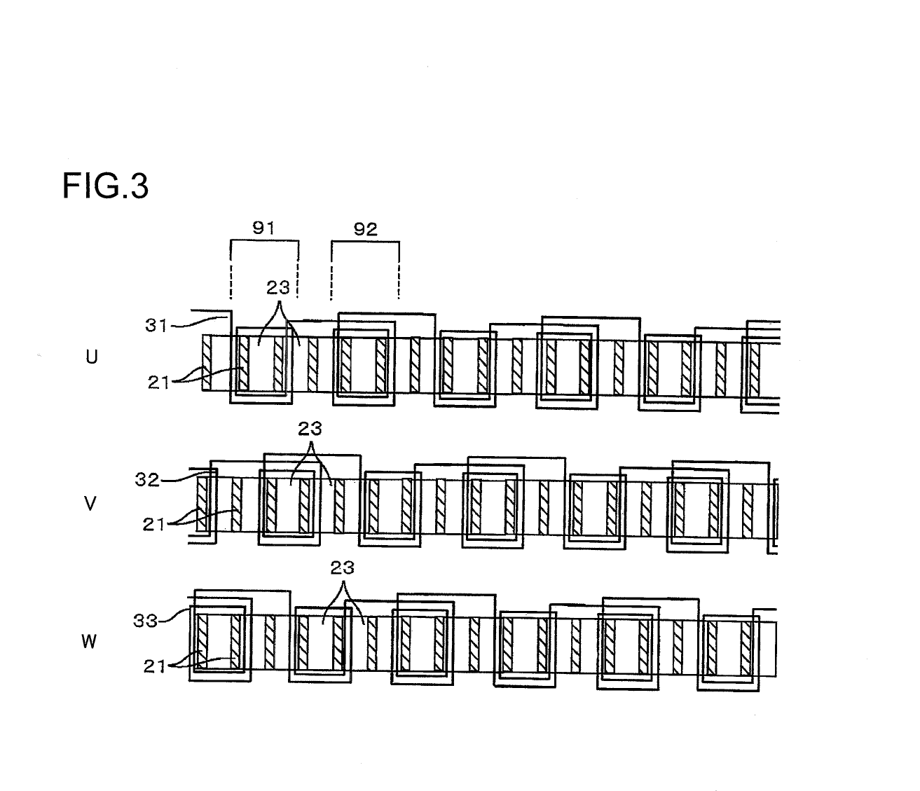

(FIG. 3) An example of a coil winding method that may be adopted in the rotating electrical machine in embodiment 3

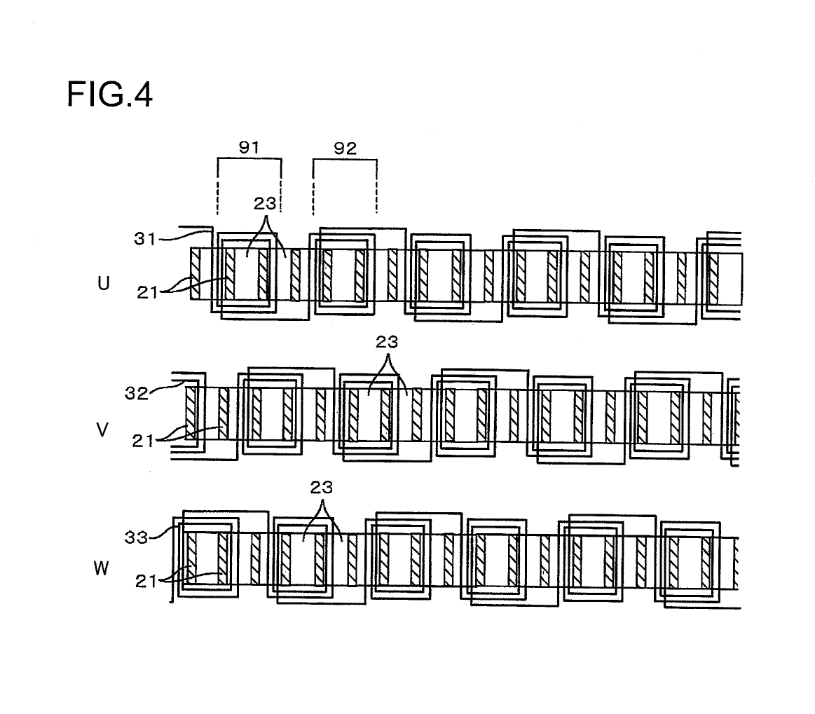

(FIG. 4) The coil winding method adopted in the vehicular AC generator in embodiment 4

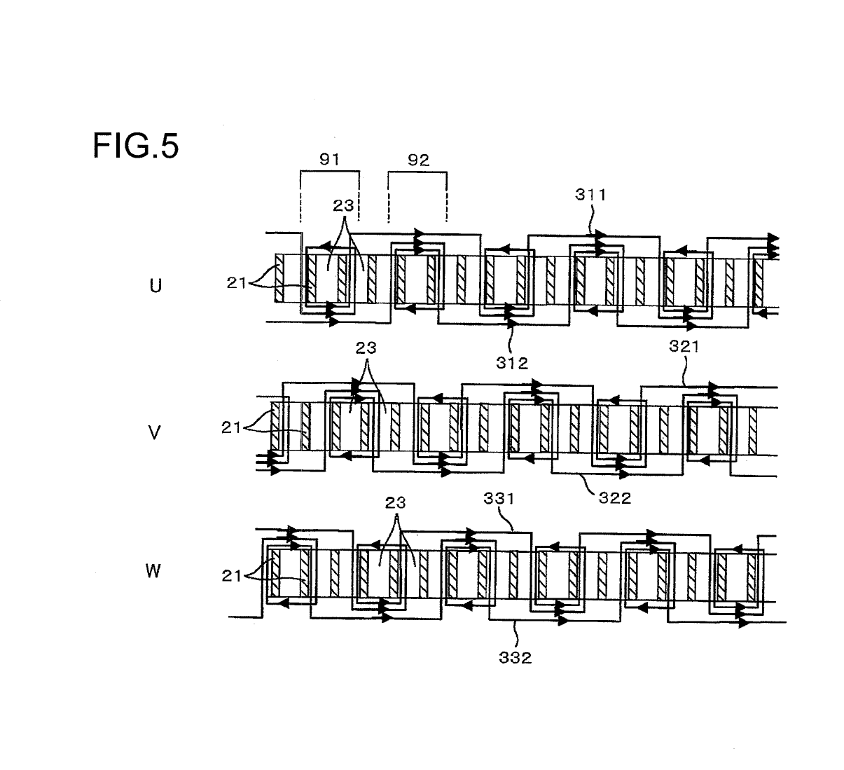

(FIG. 5) The coil winding method adopted in the vehicular AC generator in embodiment 5

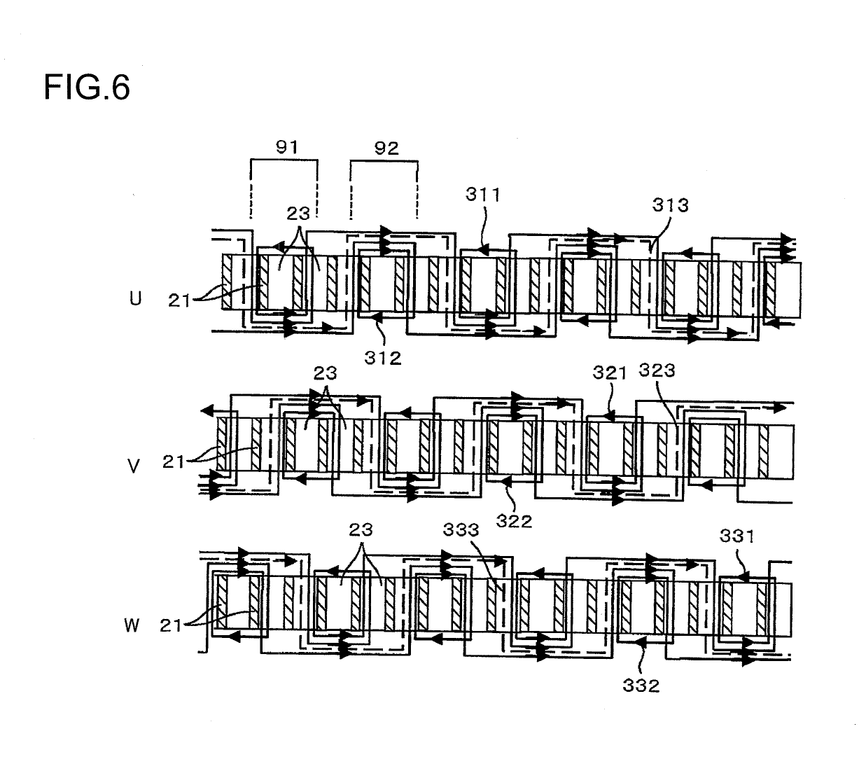

(FIG. 6) The coil winding method adopted in the vehicular AC generator in embodiment 6

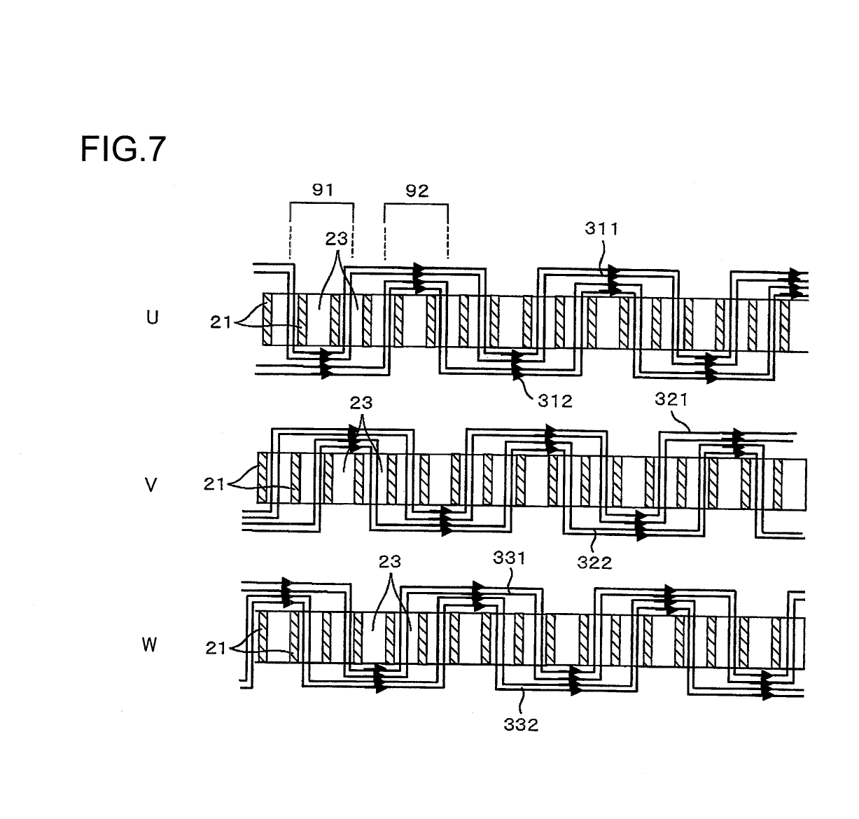

(FIG. 7) The coil winding method adopted in the vehicular AC generator in embodiment 7

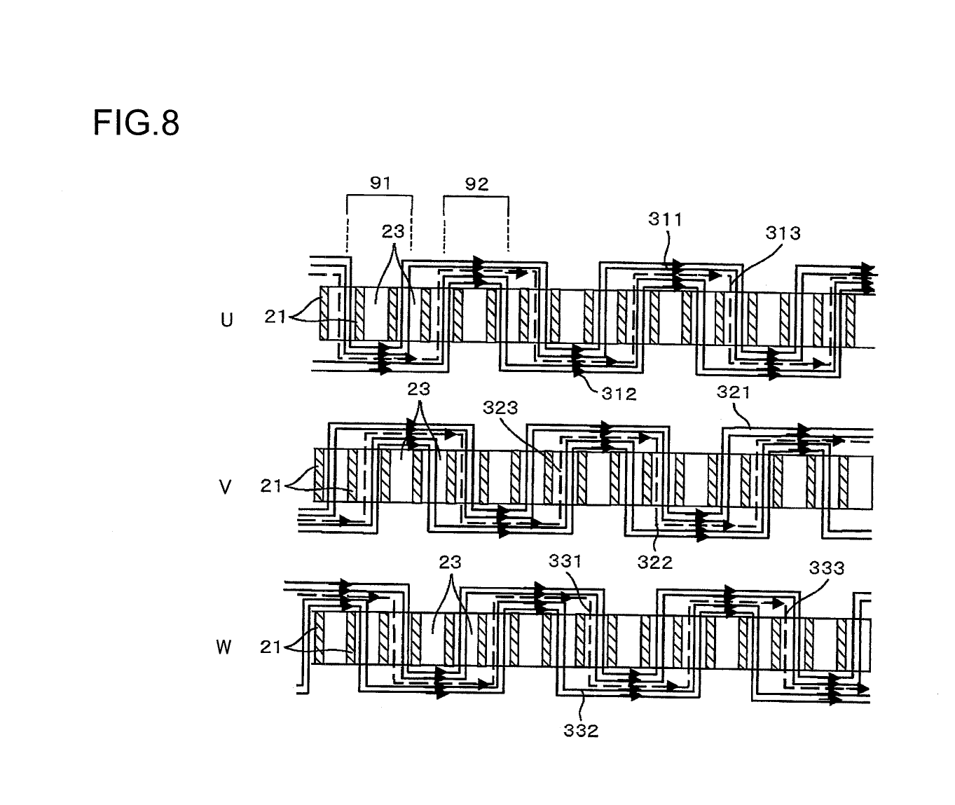

(FIG. 8) The coil winding method adopted in the vehicular AC generator in embodiment 8

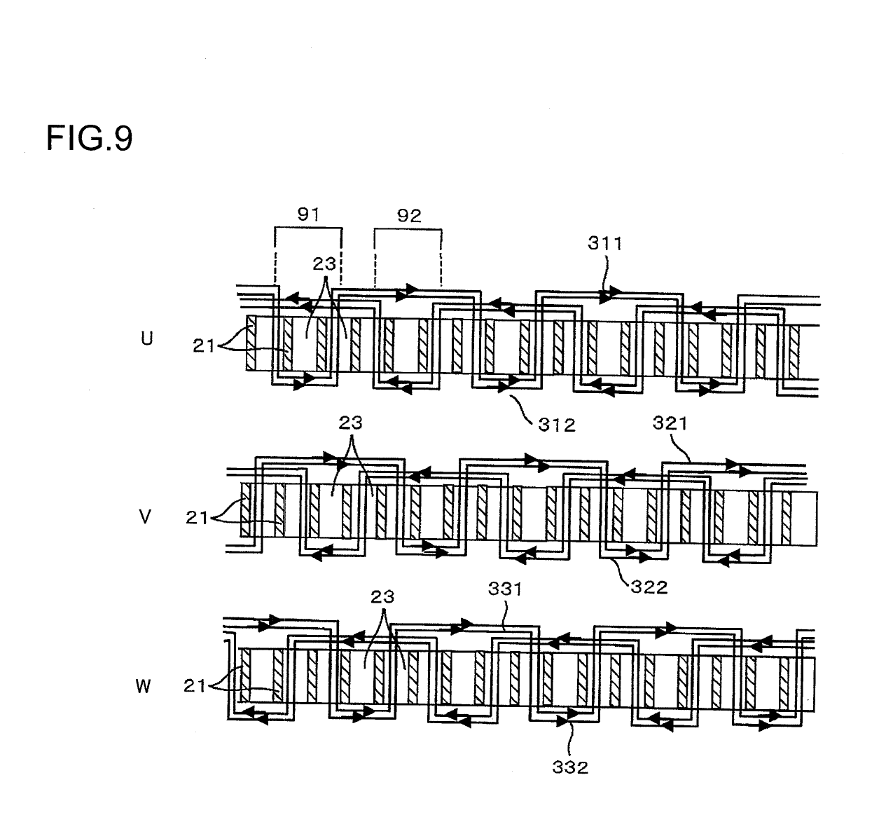

(FIG. 9) The coil winding method adopted in the vehicular AC generator in embodiment 9

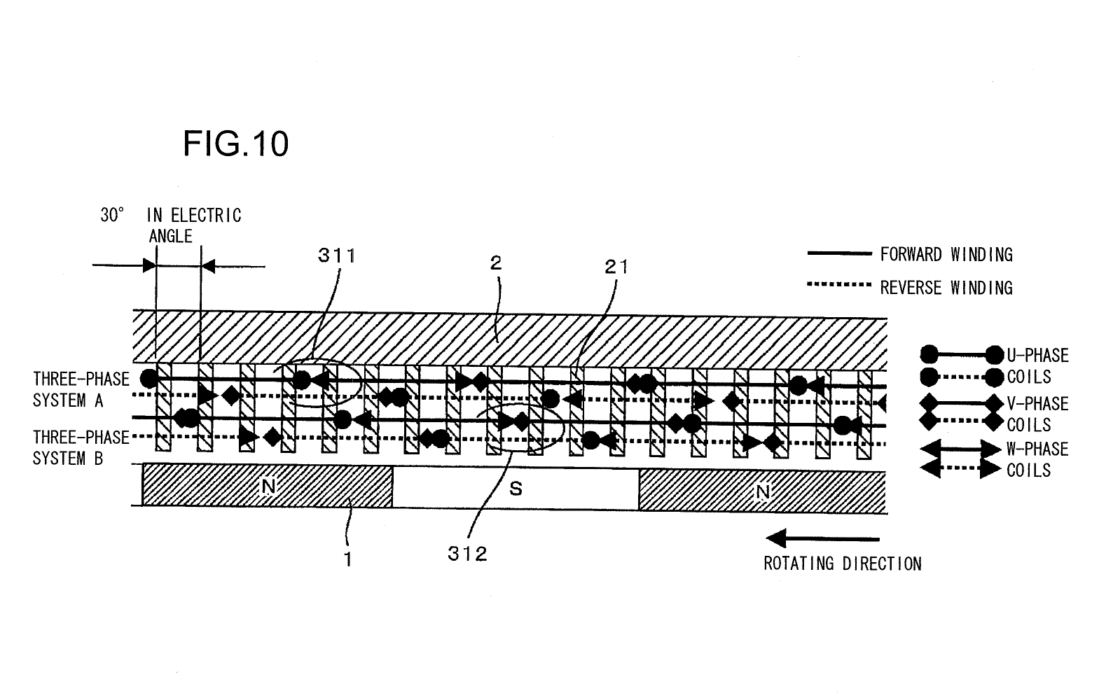

(FIG. 10) A conceptual diagram illustrating the coils in the vehicular AC generator achieved in embodiment 10

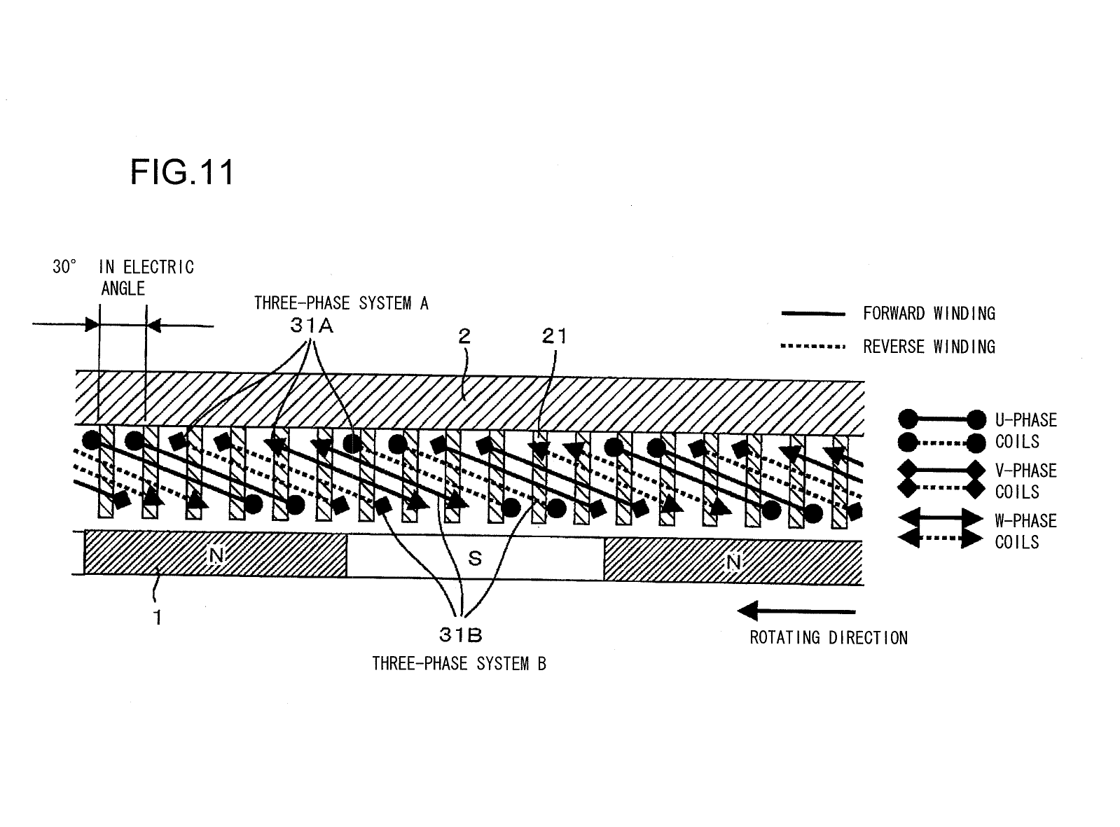

(FIG. 11) A conceptual diagram illustrating the coils in the vehicular AC generator achieved in embodiment 11

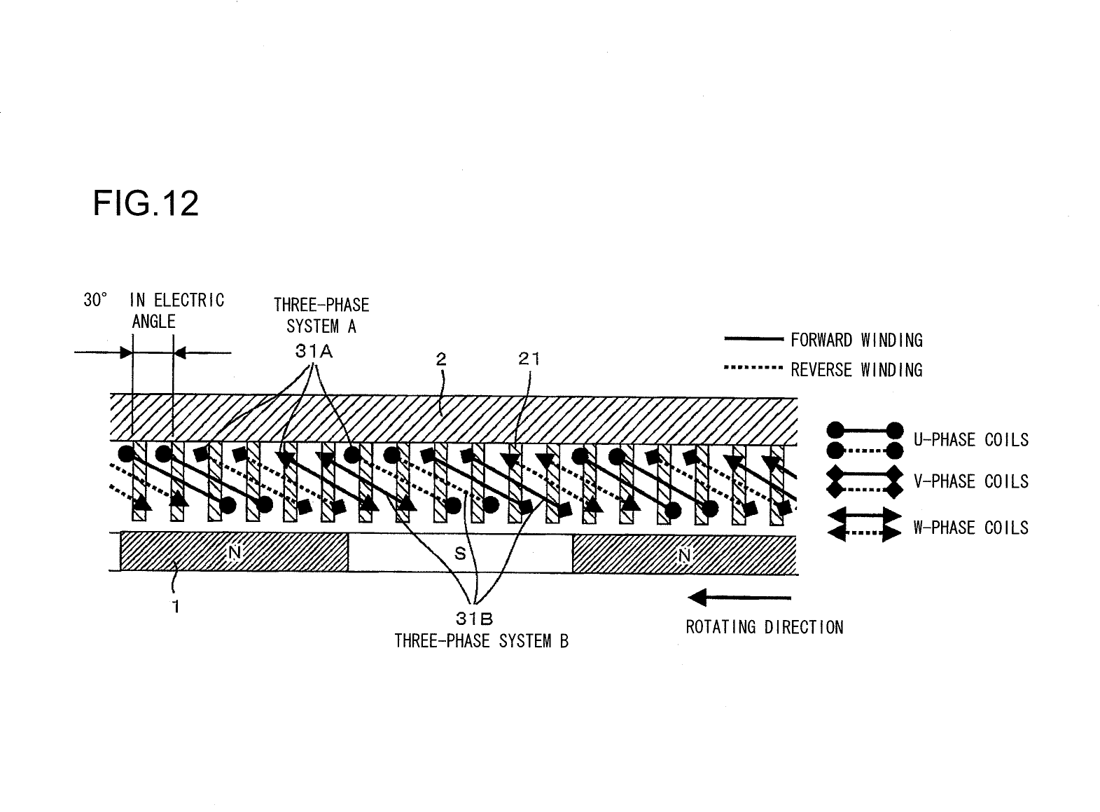

(FIG. 12) A diagram of a variation of the coil winding method shown in FIG. 11

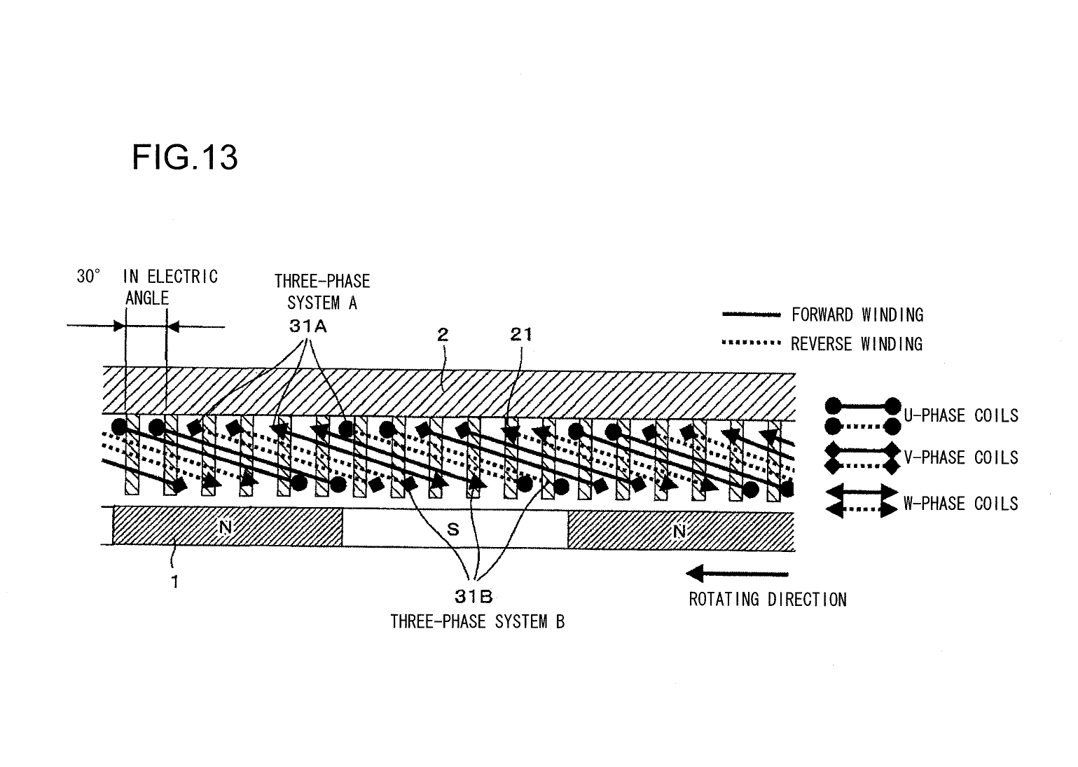

(FIG. 13) A diagram of another variation of FIG. 11

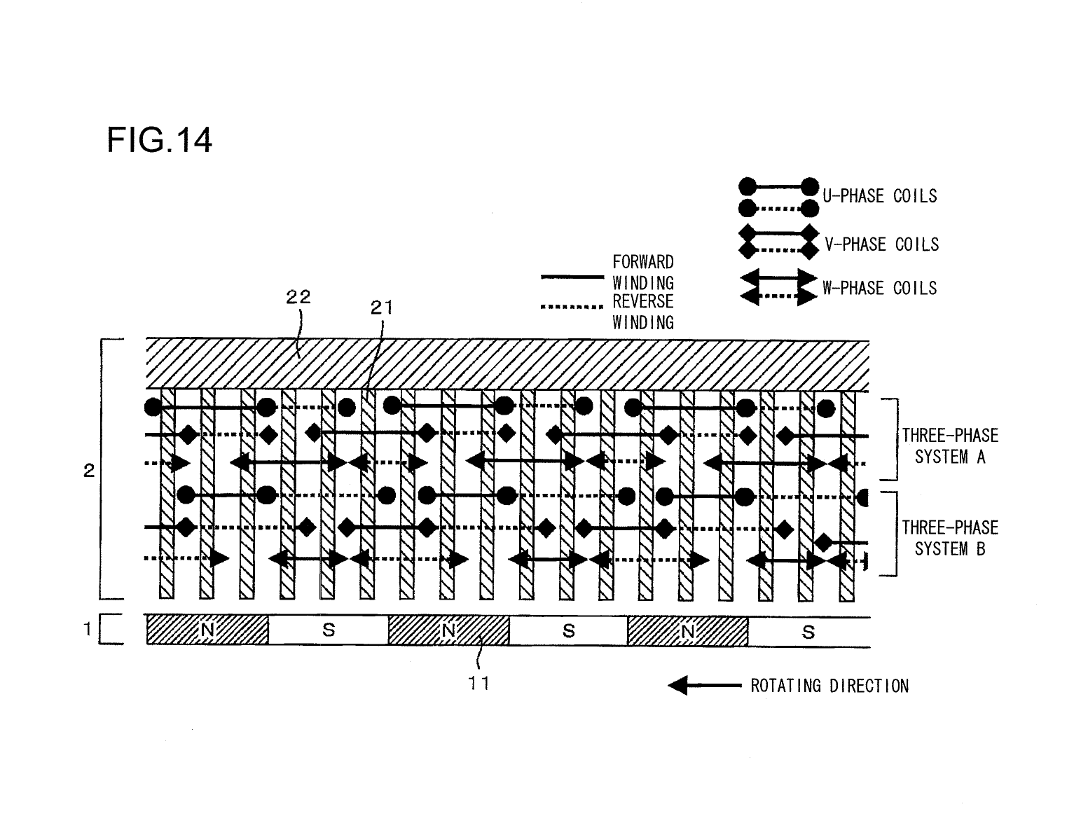

(FIG. 14) A conceptual diagram illustrating the coils in the vehicular AC generator achieved in embodiment 12

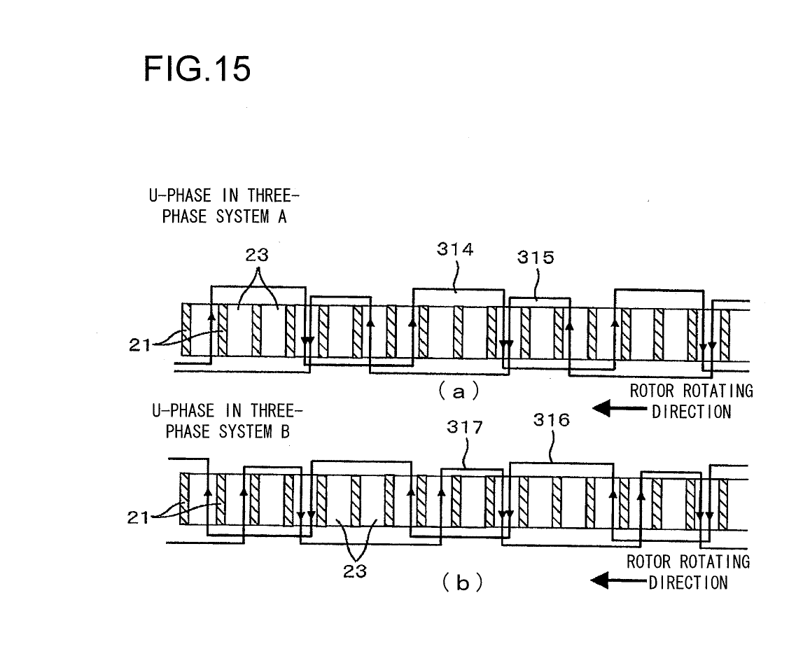

(FIG. 15) U-phase coil winding diagrams, with (a) showing the U-phase coils in the three-phase system A and (b) showing the U-phase coils in the three-phase system B

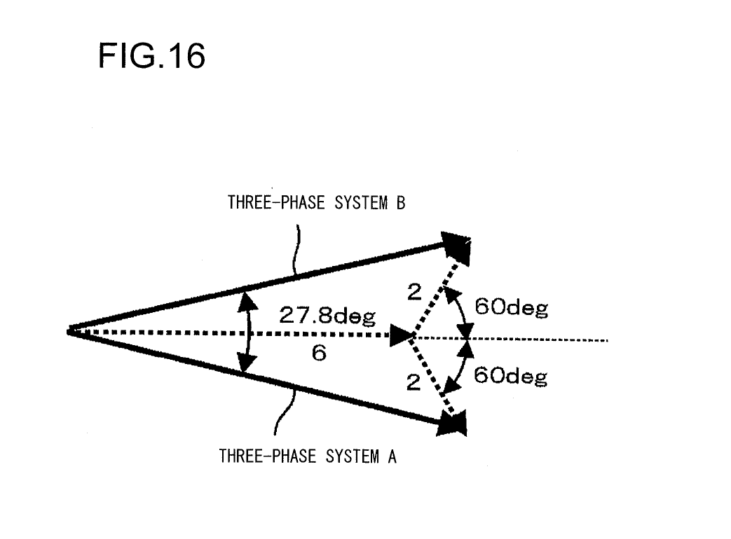

(FIG. 16) A phasor diagram indicating the quantities of magnetic flux picked up at the U-phase coils

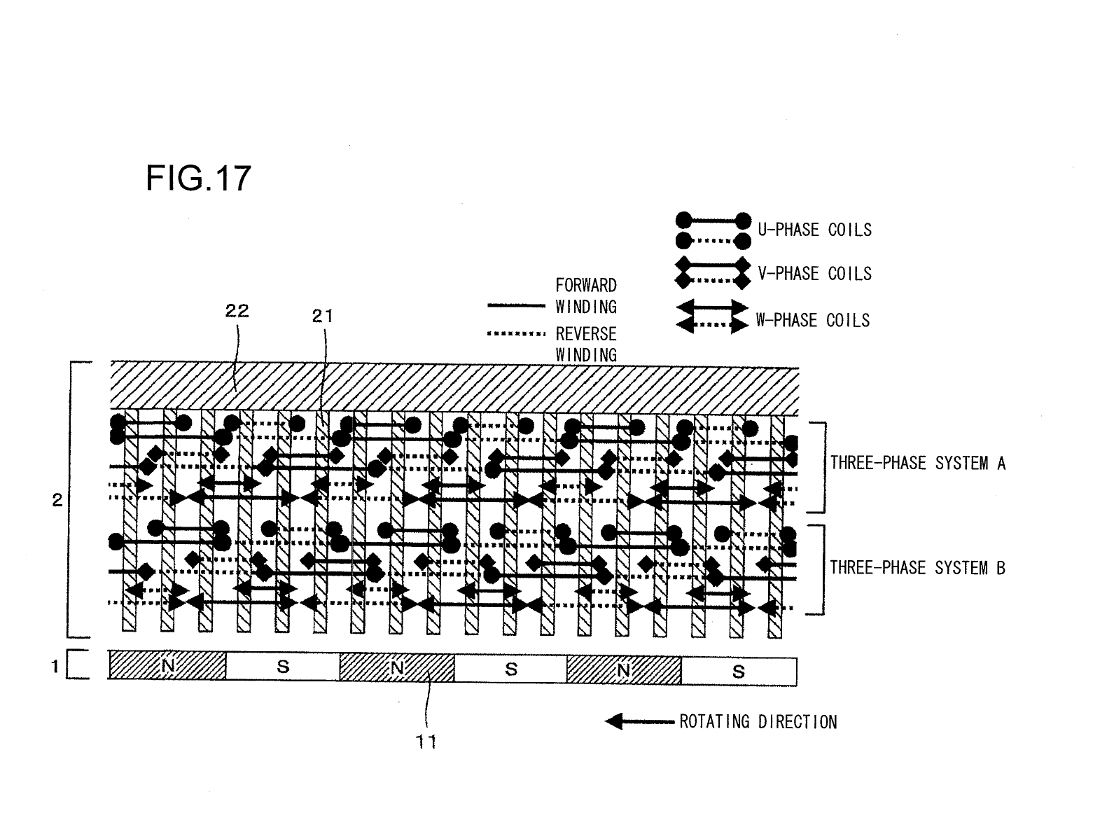

(FIG. 17) A conceptual diagram illustrating the coils in the vehicular AC generator achieved in embodiment 13

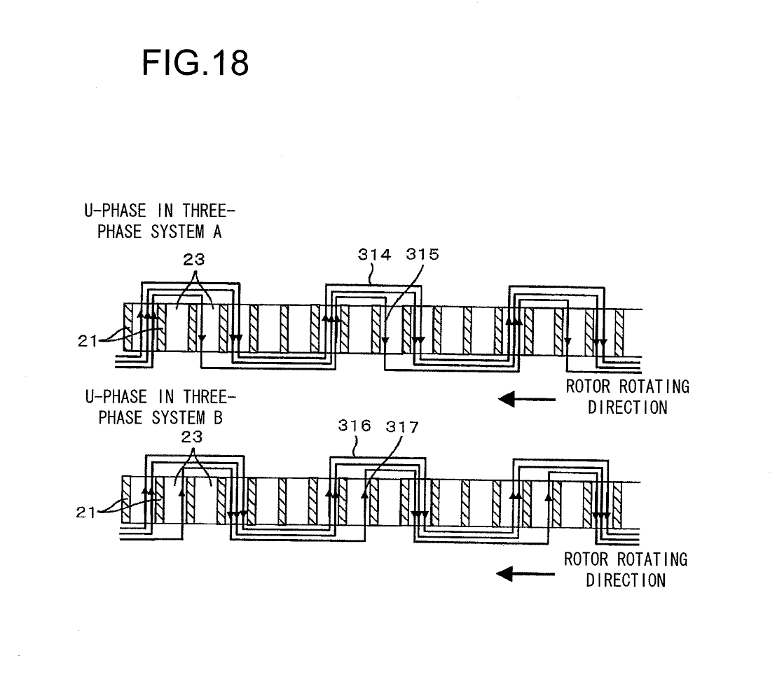

(FIG. 18) Winding diagrams pertaining to the U-phase coils in embodiment 13

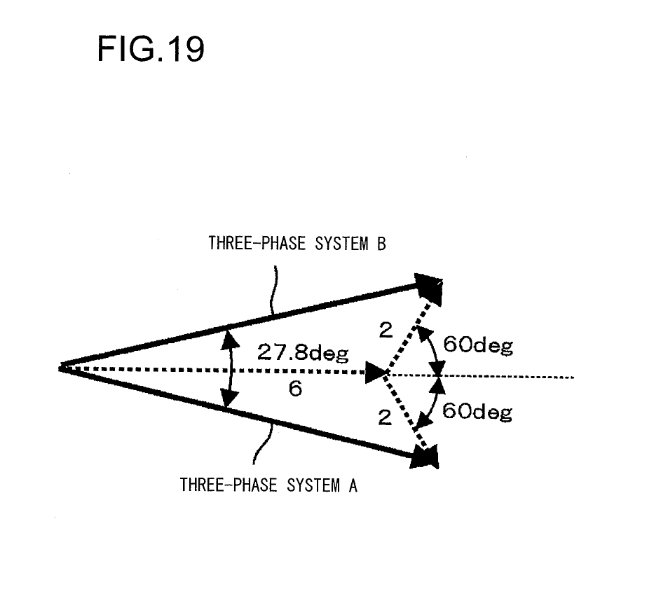

(FIG. 19) A phasor diagram indicating the quantities of magnetic flux picked up at the U-phase coils in embodiment 13

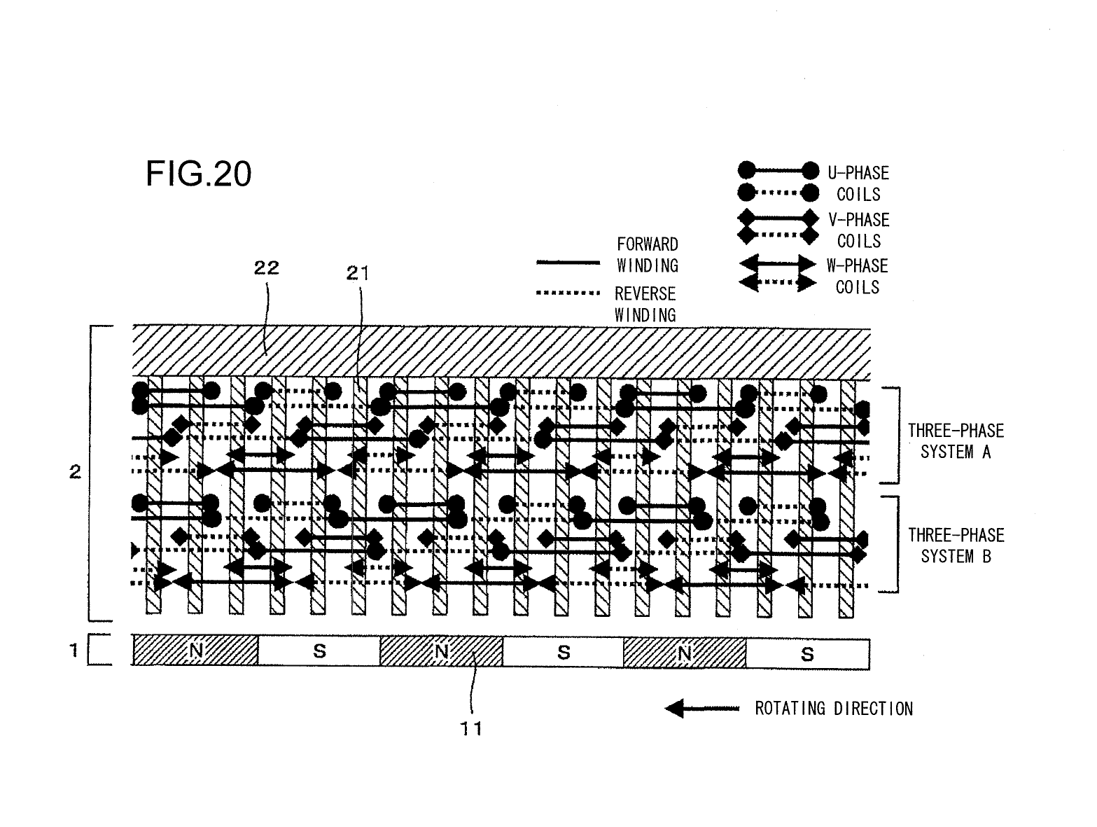

(FIG. 20) A conceptual diagram illustrating the coils in the vehicular AC generator achieved in embodiment 14

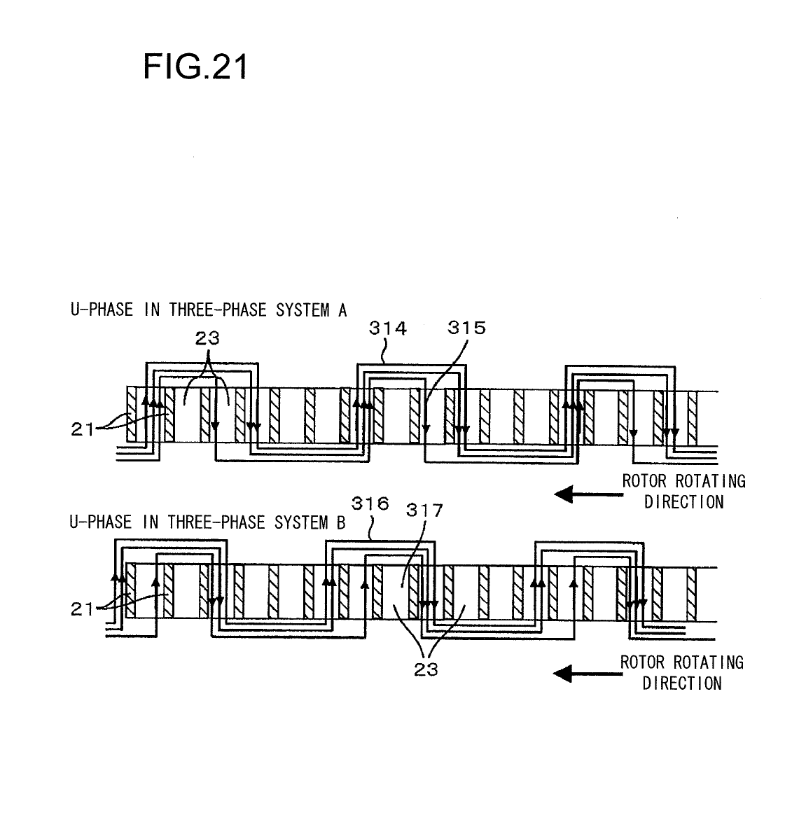

(FIG. 21) Winding diagrams pertaining to the U-phase coils in embodiment 14

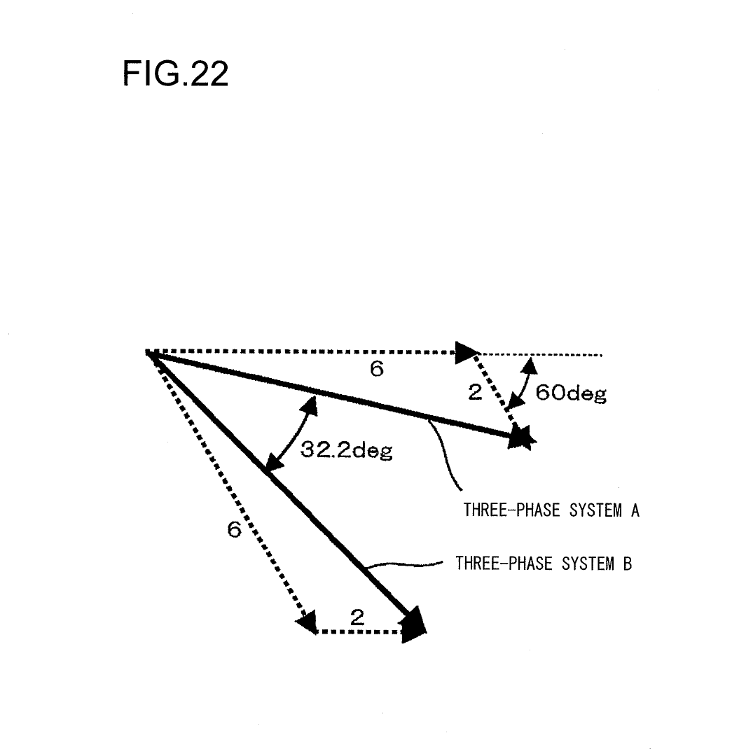

(FIG. 22) A phasor diagram indicating the quantities of magnetic flux picked up at the U-phase coils in embodiment 14

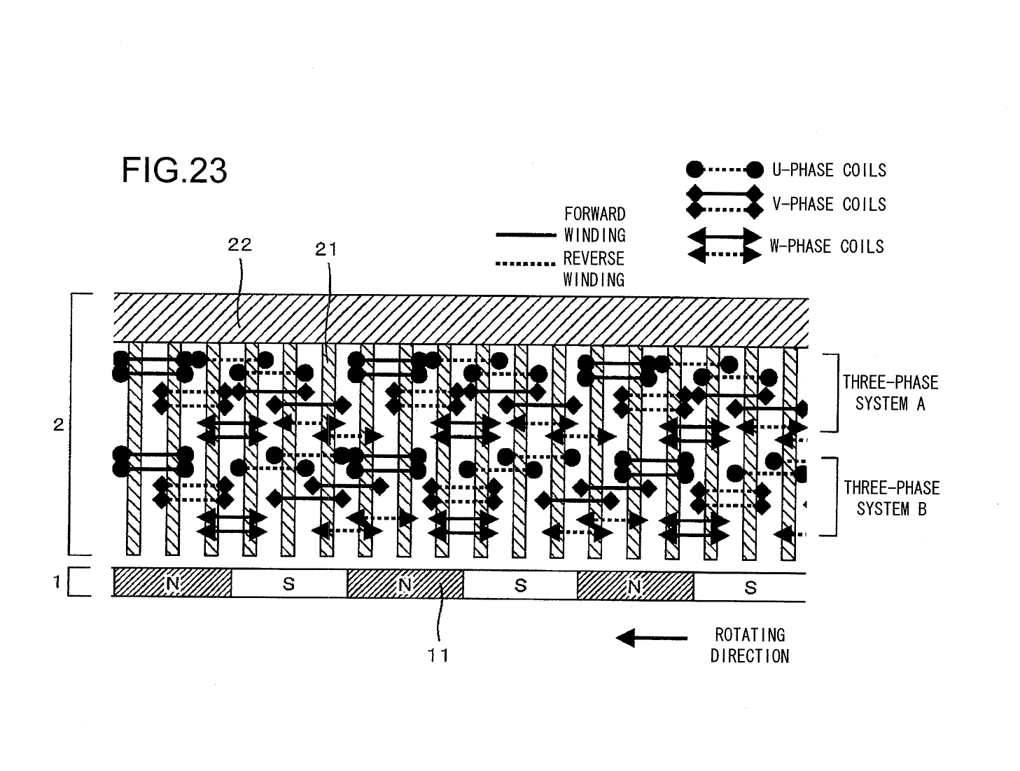

(FIG. 23) A conceptual diagram illustrating the coils in the vehicular AC generator achieved in embodiment 15

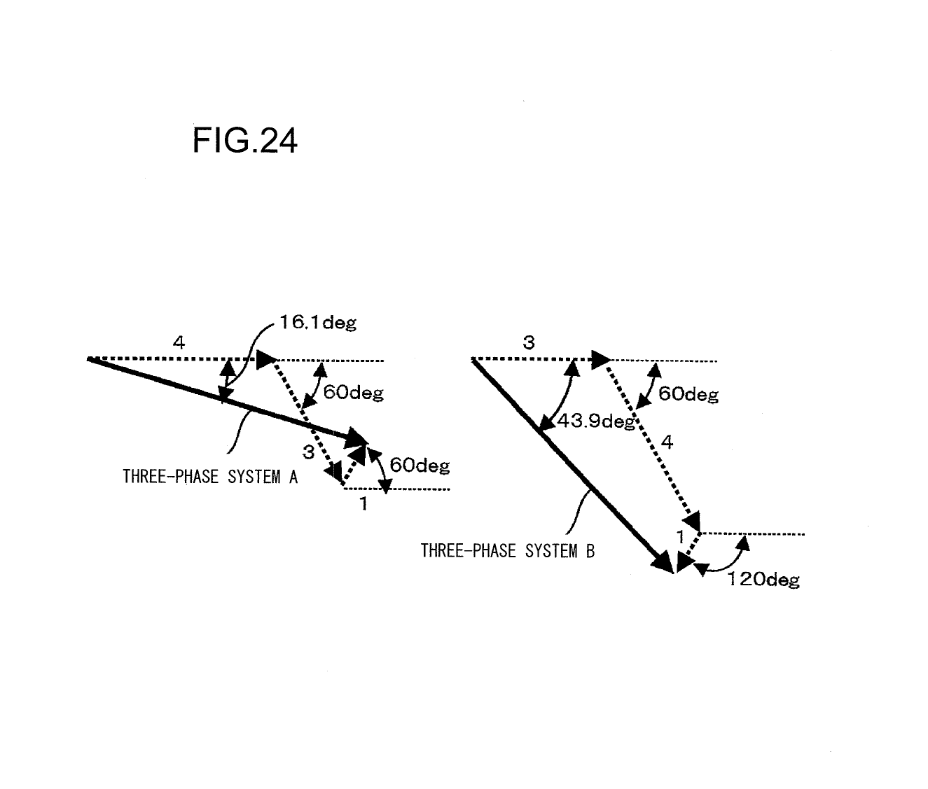

(FIG. 24) A phasor diagram indicating the quantities of magnetic flux picked up at the U-phase coils in embodiment 15

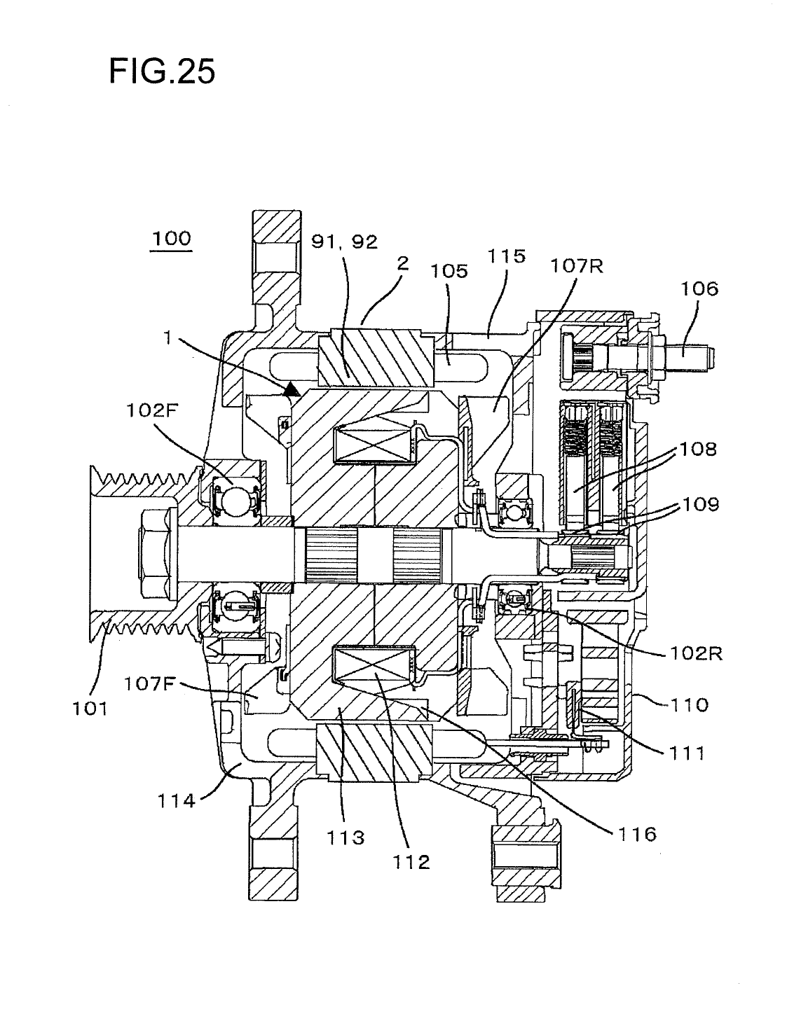

(FIG. 25) A sectional view of an air-cooled vehicular AC generator 100 achieved in an embodiment of the present invention

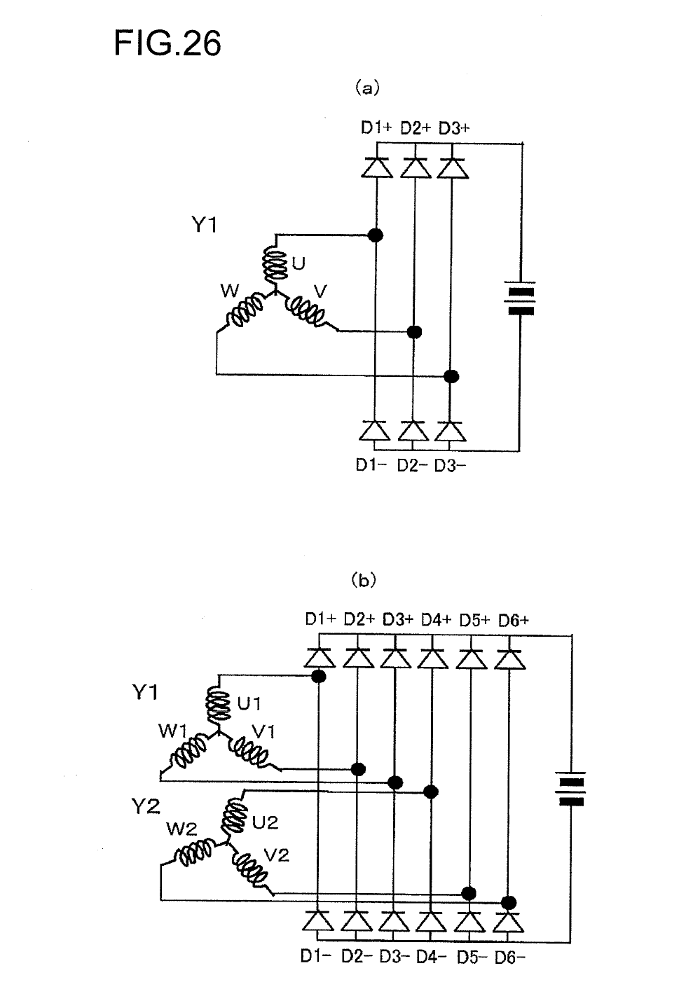

(FIG. 26) Diagrams of three-phase rectifier circuits, with (a) showing a circuit with a single three-phase Y connection and (b) showing a circuit with double three-phase Y connections

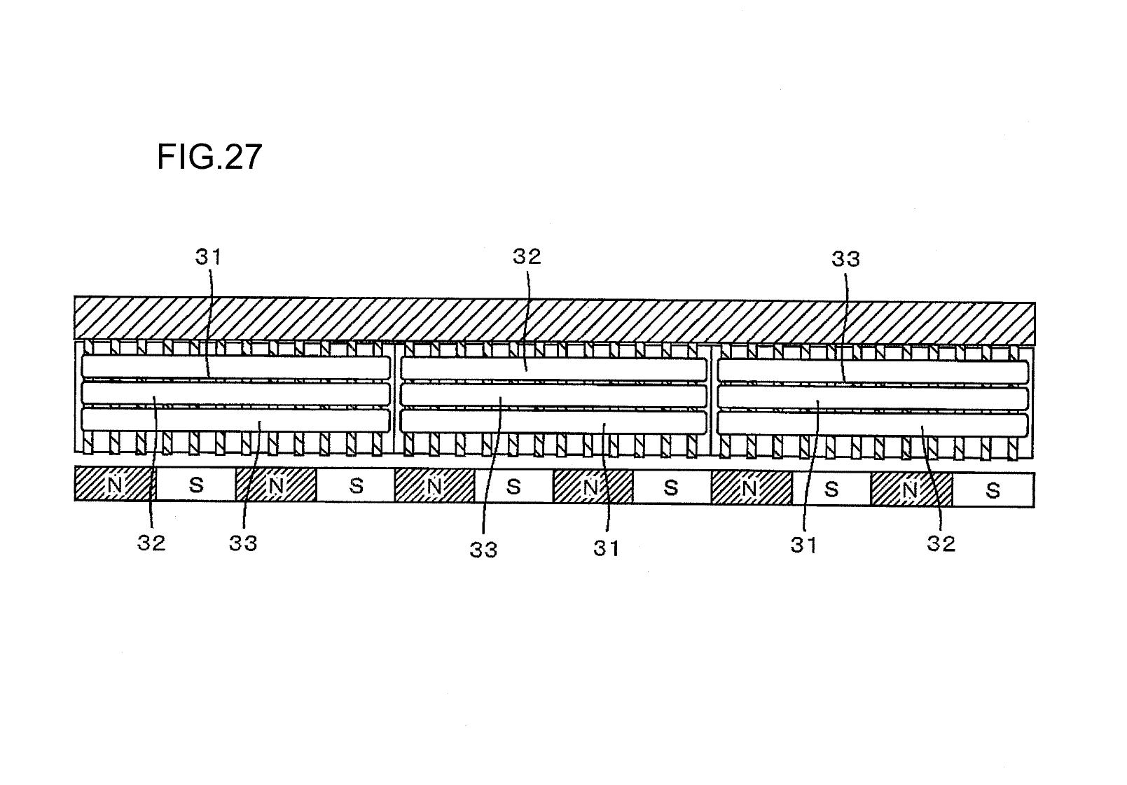

(FIG. 27) A schematic diagram of the embodiment shown in FIG. 2

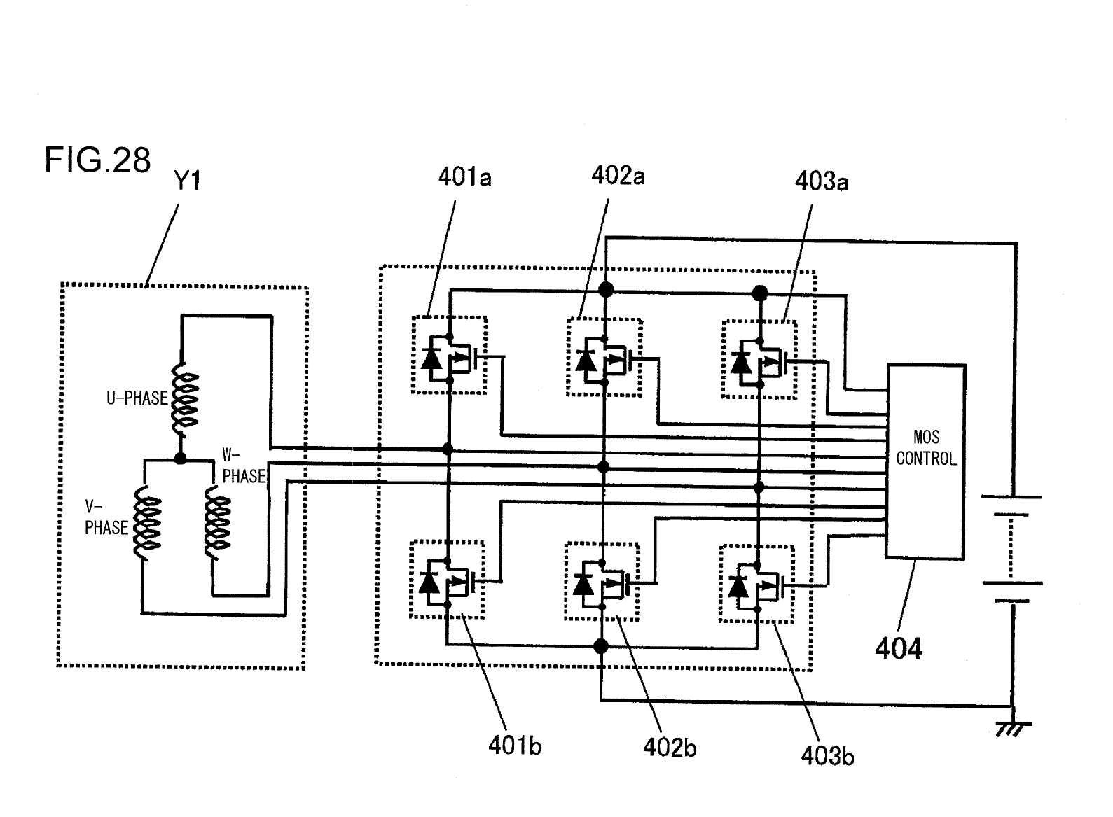

(FIG. 28) A rectifier circuit equipped with rectifier elements constituted with MOSFET diodes

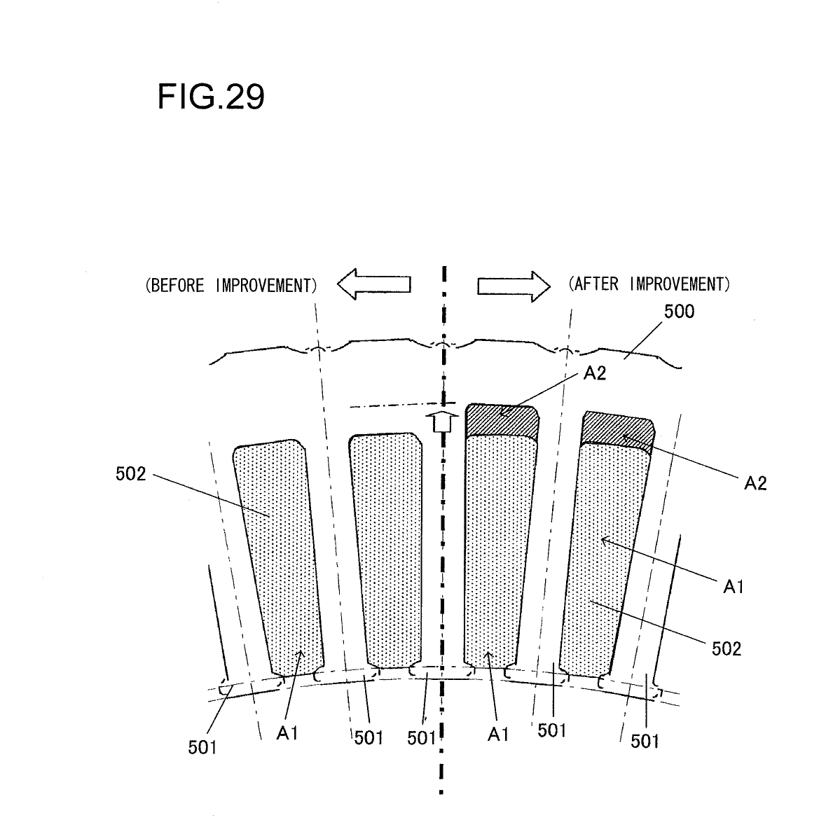

(FIG. 29) A first example of a structure that allows coils to assume greater sectional areas

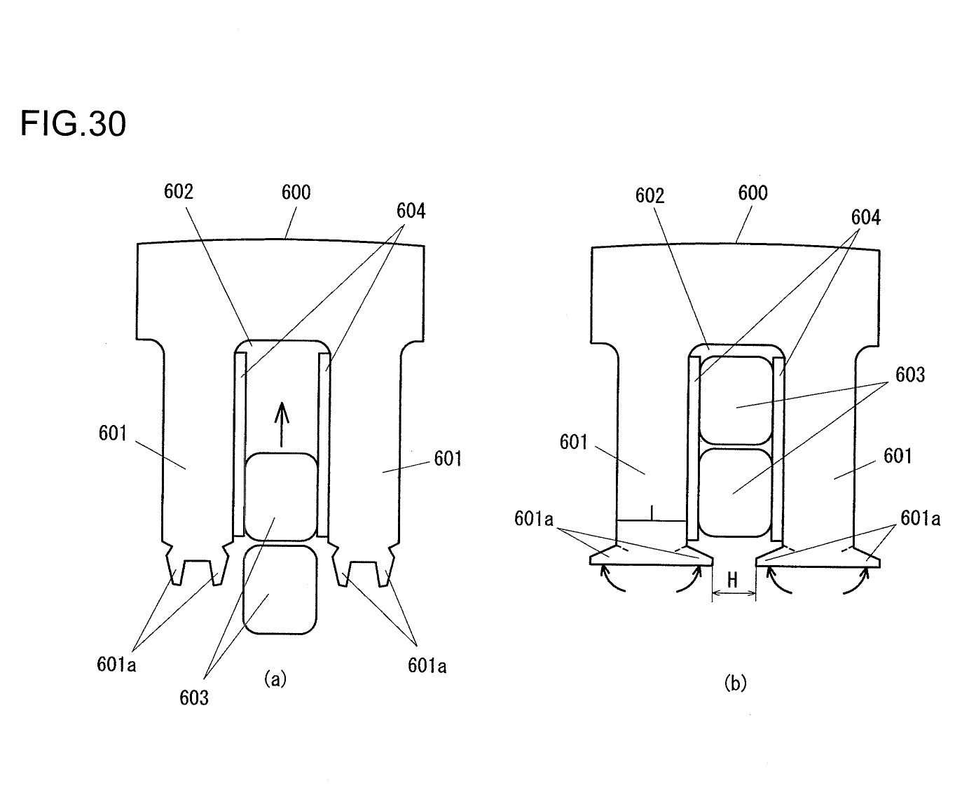

(FIG. 30) A second example of a structure that allows coils to assume greater sectional areas

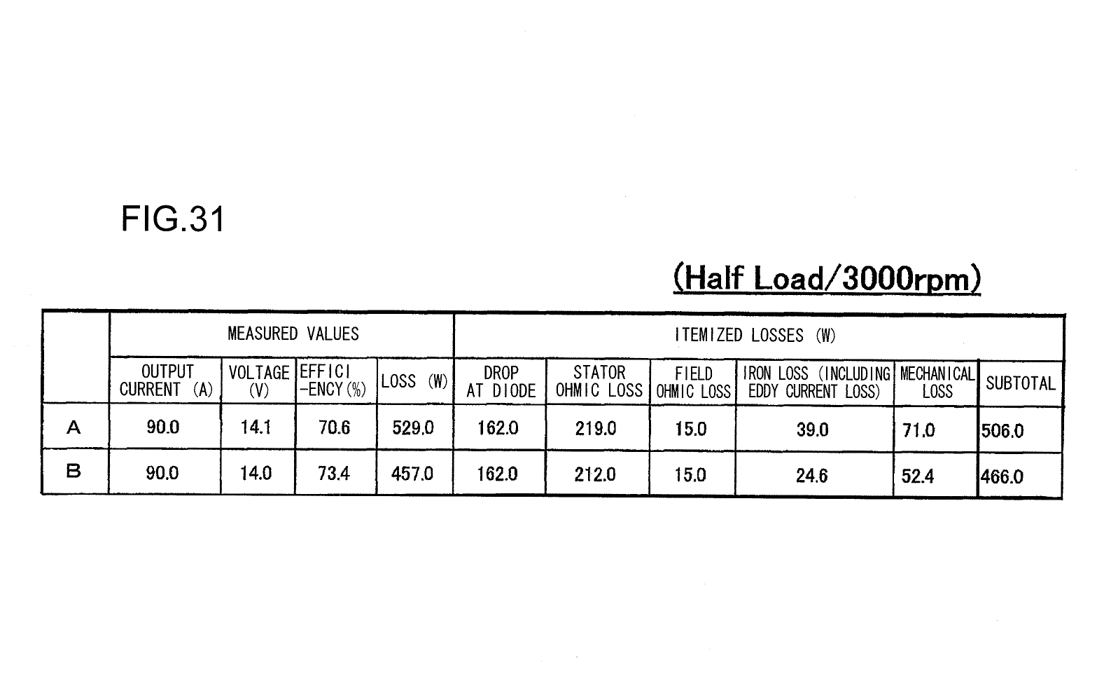

(FIG. 31) A table of values obtained by actually measuring samples A and B and the corresponding analysis results

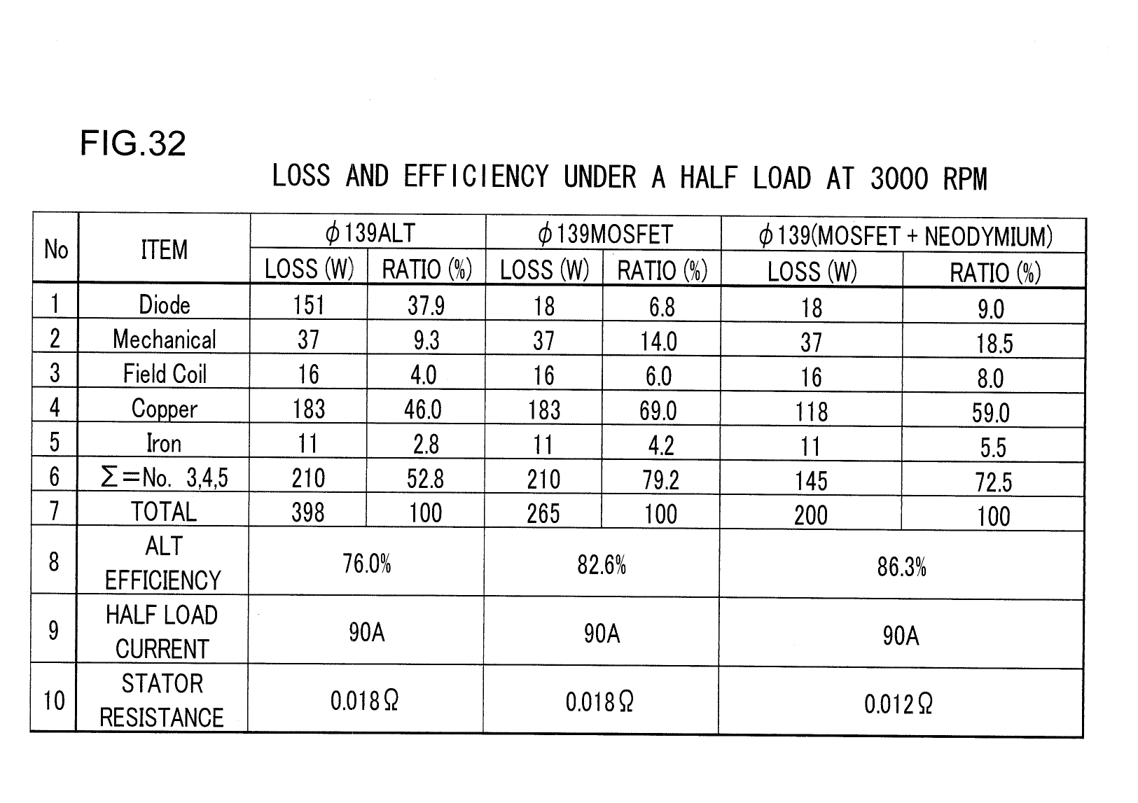

(FIG. 32) A table of analysis results obtained by analyzing data pertaining to nominal Φ 139 alternators

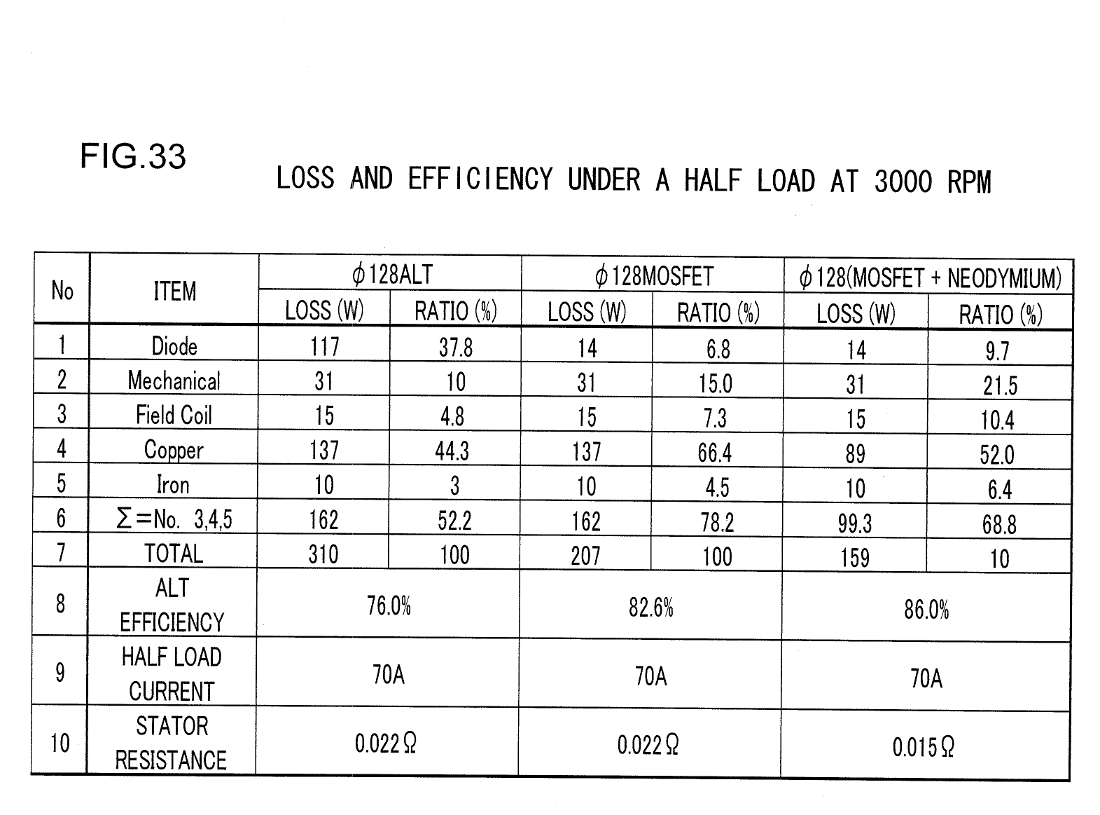

(FIG. 33) A table of analysis results obtained by analyzing data pertaining to nominal Φ 128 alternators

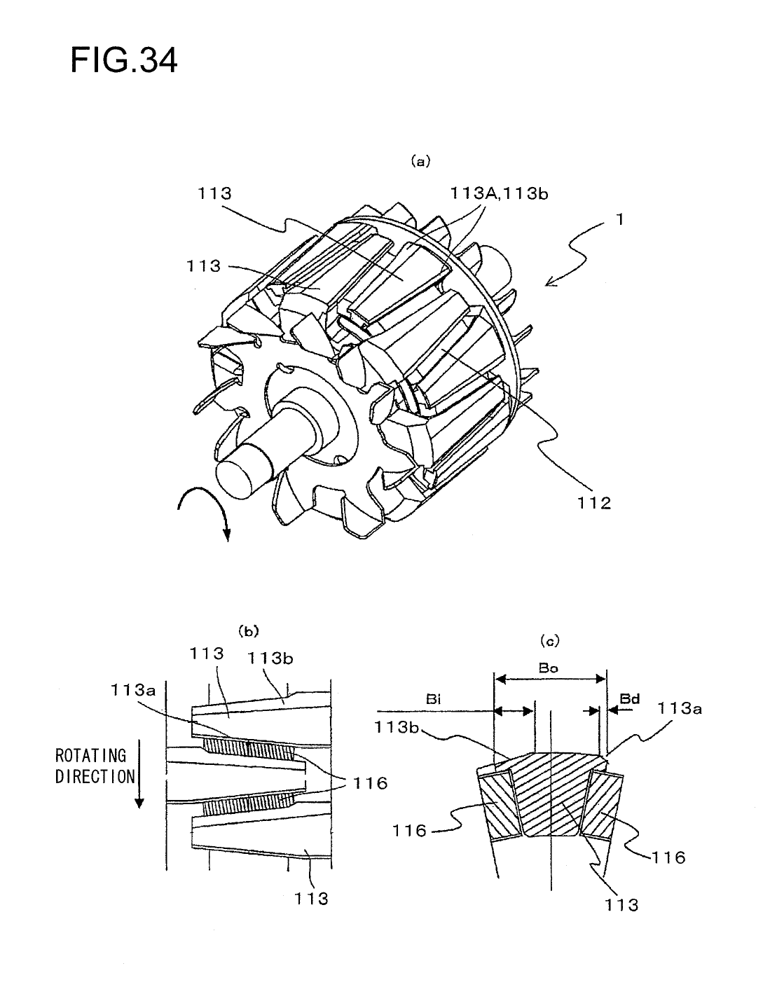

(FIG. 34) Illustrations of beveled contours with (a) showing the rotor 1 in a perspective, (b) showing claw poles 113 in a plan view and (c) showing claw poles 113 in a sectional view

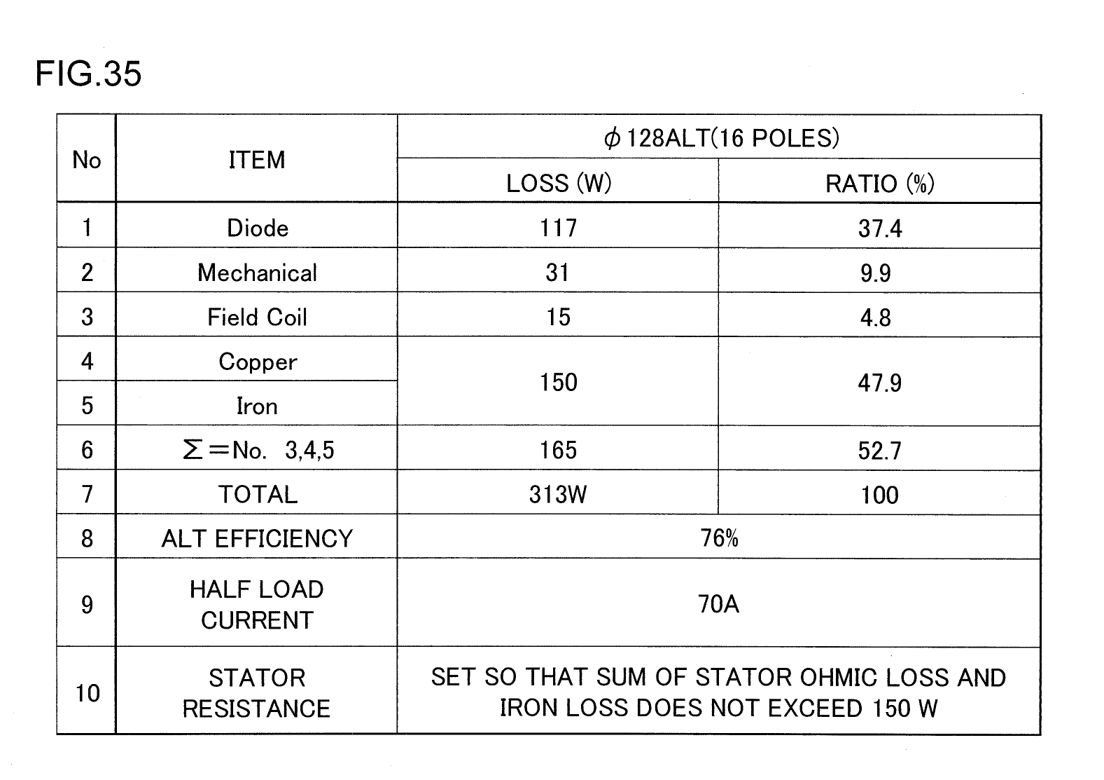

(FIG. 35) A table of analysis results obtained by analyzing data pertaining to a nominal Φ 128 alternator with 16 poles

### BEST MODE FOR CARRYING OUT THE INVENTION

The following is a description of the embodiments of the present invention. As explained earlier, in order to achieve further improvement in the efficiency of vehicular AC generators, various loss values, which are critical factors in realizing target efficiency, must be evaluated separately through better optimized loss analysis. The loss analysis method adopted in conjunction with the embodiments is first described.

Losses occurring in a vehicular AC generator (may be referred to as an alternator in the following description) are categorized as; (1) rectification loss (loss occurring in relation to rectification), (2) mechanical loss, (3) field ohmic loss, (4) iron loss (including the eddy current loss occurring at the rotor) and (5) stator ohmic loss. The extents of rectification loss, the mechanical loss, the stator ohmic loss and the field ohmic loss among these five types of losses, can be estimated relatively accurately based upon the operating conditions. However, it is difficult to measure or estimate the iron loss and, for this reason, the total iron loss can only be estimated as the difference obtained by subtracting the four other losses from the entire loss.

The iron loss analysis method adopted in conjunction with the embodiments is first briefly described. It is to be noted that the methods through which the losses other than the iron loss are calculated will be described later. The iron loss is attributed to stator iron loss and eddy current loss occurring at the rotor. However, the stator iron loss and the eddy current loss at the rotor cannot be measured separately from each other while the generator operates under a load, e.g., in a half load state. Accordingly, an iron loss value is estimated for the embodiments as described below. In a no-load state, in which a current does not flow through a stator coil, the loss (no-load loss) will include the mechanical loss and the stator iron loss attributable to the magnetic field. Thus, the iron loss in the no-load state can be ascertained by subtracting the mechanical loss from the loss measured in the no-load state.

In the actual half-load state, a magnetic field is generated by current (electrical current attributable to induced voltage) flowing through the stator coil. The phase of this magnetic field is shifted relative to the phase of the magnetic field at the rotor by 90°, and bias magnetism manifests at the claw poles at the rotor due to this. While the magnetic field at the claw poles assumes a sine wave distribution in case of no bias magnetism, the magnetic field at the claw poles is biased in the event of bias magnetism, so as to manifest a peak further toward the downstream side along the rotating direction. In the latter case, an eddy current occurring near the surfaces of the magnetic poles as a result will cause loss. For this reason, the extent of the total iron loss, including the eddy current loss occurring at the rotor when there is bias magnetism is assumed to be greater than the loss represented by the value obtained by subtracting the mechanical loss from the no-load measured loss value.

Through a loss analysis conducted by the inventor of the present invention with regard to various types of alternators, it has been learned that the extent of bias magnetism can be lowered by forming bias magnetism suppressing portions, referred to as bevels, each at one of the two edges present along the circumferential direction at a rotor claw pole, and that the extent of loss attributable to such bias magnetism can thus be minimized through the formation of the bias magnetism suppressing portions. The bias magnetism suppressing portions may assume a chamfered contour or a round shape.

FIG. 34(a) shows a rotor 1 of an alternator in perspective. It is to be noted that the overall structure of the alternator will be described later. The rotor 1 includes claw poles 113 extending along the axial direction from one end surface, and claw poles 113 extending from the other end surface in the opposite direction, which take up alternate positions along the circumferential direction. As shown in FIG. 34(b), a permanent magnet 116 is disposed in the gap present between adjacent claw poles 113. It is to be noted that FIG. 34(a) does not include an illustration of the permanent magnets 116. Bevels 113a and 113b are present each at one of the two edges (two edges facing opposite each other) along the circumferential direction at a claw pole 113. As shown in the sectional view presented in FIG. 34(c), a bevel width Bi of the bevel 113b present on the back side relative to the rotating direction is set greater than the bevel width Bd of the bevel 113a present on the front side relative to the rotating direction. By assuming a greater bevel width Bi at the bevel 113b present on the back side along the rotating direction as described above, a better bias magnetism suppressing effect is assured. It is to be noted that although not as effective as the bevels, numerous grooves formed at the surface of the rotor will also reduce the eddy current.

FIG. 31 presents a table listing measurement values and analysis values obtained by analyzing losses occurring in two samples. Sample A in FIG. 31 has no bevels formed at the rotor, whereas sample B in FIG. 31 has bevels formed at the rotor. In sample B, with bevels formed thereat, the total sum of the individual estimated losses substantially matches the total loss ascertained through actual measurement. In contrast, the total sum of the individual estimated losses greatly deviates from the total loss actually measured at sample A with no bevels formed thereat. Namely, by forming the bevels, the extent of loss attributable to bias magnetism, which is part of the iron loss, is reduced and as a result, the individual losses making up the total loss ascertained through the actual measurement can be analyzed more accurately. At the same time, since the beveling effect can be estimated with a certain degree of accuracy based upon the analysis results, the total iron loss can be estimated based upon the value representing the estimated beveling effect and the value obtained by subtracting the mechanical loss from the no-load loss measurement value.

The efficiency of vehicular AC generators is evaluated through the method stipulated by the VDA (Verband der Automobil Industrie), which is at present considered to be the most reliable high efficiency evaluation index. In the evaluation method, values at 1800 rpm, 3000 rpm, 6000 rpm and 10,000 rpm are weighted respectively at 25%, 40%, 25% and 10% relative to half-load data for purposes of evaluation. In reference to the embodiments, losses are examined by adopting this evaluation method.

The following description is given in reference to an example in which 75% efficiency is achieved in a nominal Φ 139 alternator (with an output of 180 A). Assuming that the output current and the output voltage in the half-load state are respectively 90 A and 14V, the following conditions must be satisfied in order to achieve 75% efficiency. It is to be noted that the term “nominal Φ 139 alternator” refers to an alternator with a specific size represented by its outer diameter dimension. The outer diameter of the nominal Φ 139 alternator is normally within a range of Φ 137˜Φ 141. In addition, while it will be obvious that the voltage output from the alternator in actual operation is bound to fluctuate within an approximate range of 14±0.5 V and thus the calculation results (the loss and resistance value to be detailed later) are also bound to assume a certain range corresponding to the range over which the output power fluctuates, the following description is given by assuming that the output power is fixed at 14 V.

output: 14 V×90 A=1260 W
input: 1260 V÷0.76≈1658 W
loss: 1658 W−1260 W=398 W

As explained earlier, the total loss is attributed to (1) rectification loss (loss related to the rectification), (2) mechanical loss, (3) field ohmic loss, (4) iron loss (which includes the eddy current loss occurring at the rotor surface) and (5) stator ohmic loss. In the example described below, the various types of losses in an alternator assuring the highest level of efficiency at the present time (hereafter referred to as an “actual unit”) are analyzed and conditions that are needed to be fulfilled in order to achieve the desired level of efficiency are determined based upon the analysis results. In other words, conditions that will allow a total loss equal to or less than 398 W are determined.

(1) Rectification Loss

The value representing the rectification loss, which occurs at diodes in a rectifier circuit, is dependent upon a decrease in the forward-direction voltage occurring at the diodes. The description is given in specific terms by assuming that the forward-direction voltage drop occurring at the diodes in the half-load (90 A) state is 0.84 V. It will be difficult to reduce the forward-direction voltage drop beyond 0.84 V obtained through actual measurement of a forward-direction voltage drop at a p-n junction diode. Accordingly, the rectification loss should be calculated as; 90 A×0.84 V×2≈151 W. As long as a p-n junction diode is used for a rectifier element, it will not be possible to reduce the rectification loss beyond this value.

(2) Mechanical Loss

No current flows through a stator coil in a no-load state, in which a stator coil terminal is left in an open state. Accordingly, it can be safely assumed that as long as there is no field current and no load is applied, only the mechanical loss will be measured, since the losses related to an electrical current or a magnetic field (the ohmic loss and the iron loss) do not occur. The loss measured when there is no field current and no load is applied, is thus designated as the mechanical loss in relation to the embodiments. Measurement data obtained by measuring losses at the actual unit indicate that losses occurring in the no field current/no load state at various rotation rates, which are selected for purposes of half-load evaluation, are 8 W (1800 rpm), 18 W (3000 rpm), 56 W (6000 rpm) and 140 W (10,000 rpm). Accordingly, the mechanical loss in the half-load state should be calculated as;

8 W×0.25+18 W×0.4+56 W×0.25+140 W×0.1≈37 W.

(3) Field Ohmic Loss

The field current in the half load state (90 A) is 2.5 A at 3000 rpm. Since the field current becomes less than 2.5 A when the rotation rate is higher than 3000 rpm, the highest level of field ohmic loss corresponding to 2.5 A is calculated. Assuming that the temperature of the field coil is 100° C. and the resistance value at the field coil at room temperature is 2.0Ω, the field ohmic loss should be calculated as;

2.0Ω×(234.5+100)/(234.5+20)×2.5²≈16 W.

(4) Iron Loss

While the iron loss is analyzed as has already been explained, the iron loss in the no-load state can be ascertained by subtracting the mechanical loss from the loss measured in the no-load state as described above. For instance, a no-load state loss of 11 W is calculated by subtracting the no-load loss measurement value at 3000 rpm from the mechanical loss of 18 W at 3000 rpm. The no-load state loss of 11 W calculated as described above for the actual unit used in conjunction with the embodiments, with bevels formed at the rotor thereof, is close to the actual measurement value, indicating that the total sum of the individually ascertained losses and the actual total loss substantially match each other.

The iron loss is normally calculated as expressed in “iron loss ∞ f²×Bm²” with f representing the frequency and Bm representing the magnetic flux density. As the rotation rate (frequency) in an alternator increases, the magnetic flux density decreases in inverse proportion. Accordingly, the iron loss (including the eddy current loss at the rotor) is considered to remain constant regardless of the rotation rate. In other words, the loss value of 11 W calculated in correspondence to a rotation rate of 3000 rpm can be regarded as the iron loss in the VDA base. It is to be noted that the stator cores of the vehicular AC generators achieved in the embodiments are constituted with an electromagnetic steel plate assuming a thickness of 0.35 mm and manifesting a loss of 2.16 W/kg in correspondence to a frequency of 50 Hz and a magnetic flux density of 1.5 T, so as to minimize the iron loss. While the electromagnetic steel plate used in the embodiments manifests a loss of 2.16 W/kg at the magnetic flux density of 1.5 T, the present invention may be adopted in conjunction with an electromagnetic steel plate manifesting a loss of 2.15 through 3.0 W/kg. In addition, the electromagnetic steel plate may assume a thickness of 0.5 mm instead of 0.35 mm.

(5) Stator Ohmic Loss

The stator ohmic loss may be calculated as expressed below with r representing the value of resistance at the primary stator at room temperature, assuming that the temperature of the stator coil is 80° C. It is to be noted that the stator coil is connected through a double star connection and that the resistance value r corresponds to a single-phase coil in the double star connection. In addition, 0.817 is a coefficient used when converting a DC current to an AC current.

rΩ×(234.5+80)/(234.5+20)×6×(0.817×90 A/2)²≈10022r

As described earlier, in order to achieve 76% efficiency or better in the nominal Φ 139 alternator (output: 180 A), it must be ensured that the total sum of the individual types of losses mentioned earlier does not exceed 398 W. Provided that the lost values calculated as described earlier are valid in the actual unit designed to minimize the rectification loss, the mechanical loss, the field ohmic loss and the iron loss, 76% efficiency or better is likely to be achieved by ensuring that the stator ohmic loss satisfies the condition expressed below while designing the stator coil.

(Stator ohmic loss)≦398−151 W+37 W+16 W+11 W)=183 W

Accordingly, if the resistance value r of the stator coil is set so that “r≦0.018Ω”, in order to satisfy the condition “10022r≦183 W”, 76% efficiency or better will be achieved. While the resistance value r is represented with two effective digits by taking into consideration the width of the output voltage and the like mentioned earlier, the resistance value 0.018Ω should be considered to assume a certain range that will include, for instance, 0.018*Ω or 0.017Ω* (* represents a given number). The total loss manifesting in an alternator has never been examined by analyzing the individual types of losses as separate and distinct elements in the related art. However, by adopting the analysis method adopted for the embodiments allows a specific target stator ohmic loss, which should be assured in order to achieve the desired efficiency, to be accurately ascertained.

The data obtained in relation to the nominal Φ 139 alternator (output 180 A) as described above, are presented in the column “Φ 139 ALT” in FIG. 32. Substantially 76% efficiency can be achieved in the nominal Φ 139 alternator by ensuring that the ohmic loss does not exceed 185 W. In addition, in a stator coil assuming a double star connection, the resistance value at a coil corresponding to each phase should be set to 0.018Ω or less, as explained earlier. This means that the coil resistance in a single star connection should be set to a value half (equal to or less than 0.009Ω) the coil resistance value in the double star connection. Likewise, the coil resistance in a double Δ connection should be set to a value three times the resistance value in the double star connection, whereas the coil resistance in a single Δ connection should be set to a value three times the resistance value in the single star connection. Furthermore, the current technologies make it possible to set specific lower limits to the values representing the rectification loss, the mechanical loss and the field ohmic loss with some accuracy, as explained earlier. A further improvement in the efficiency (better than 76%) may be achieved, in principle, by setting the stator ohmic loss to a value less than the sum of the rectification loss, the mechanical loss and the field ohmic loss. As an alternative, the sum of the stator ohmic loss and the iron loss may be set to a value equal to or less than a predetermined value at which the required efficiency can be achieved.

While p-n junction diodes are used as rectifier diodes in the example described above, the rectification loss may be reduced by using Schottky diodes that assure an even smaller extent of forward-direction voltage drop. The forward-direction voltage drop occurring at a Schottky diode will be approximately ¾ of that occurring at a p-n junction diode. While the forward-direction voltage drop at the p-n junction diode is 0.84 V with a temperature Ta at 100° C. and a forward direction current of 30 A, the forward-direction voltage drop occurring at the Schottky diode under identical conditions will be 0.55 v. In the latter case, the rectification loss will be calculated as “98×0.55 V×2=99 W”, achieving a total loss of 346 W and 79% efficiency.

In addition, by using a synchronous rectifier circuit that includes rectifier elements constituted with MOSFETs having a lower ON resistance, instead of a rectifier circuit constituted with diodes, the rectification loss accounting for a relatively high proportion of the overall loss can be further reduced so as to achieve an even greater improvement in the efficiency (see the “Φ 139 MOSFET” column in FIG. 32). The extent of voltage drop is kept down to approximately 0.1 V in conjunction with the rectifier circuit constituted with a MOSFET. As a result, the rectification loss can be greatly reduced to;

90 A×0.1V×2=18 W

The total loss in this case will be 265 W (=398 W−151 W+18 W), and the alternator efficiency will be improved to 82.6%.

Furthermore, a structure that includes permanent magnets, to act as auxiliary magnetizers in order to increase the field coil magnetic flux, disposed between the claw poles, as described in further detail later, is known in the related art. By disposing a permanent magnet constituted with a neodymium magnet between successive claw poles, an induced voltage can be increased, and the stator ohmic loss can be reduced by reducing the number of turns at the stator coil. In the column notated as “Φ 139 (MOSFET+neodymium)” in FIG. 32, the losses, the efficiency and the stator coil resistance value of an alternator equipped with a MOSFET rectifier circuit and neodymium magnets with the number of turns at the stator coil reduced from eight turns to six turns are indicated. In this alternator, the rectification loss and the stator ohmic loss are reduced and its efficiency is improved to 86.3%. The resistance value at the stator coil in the alternator is 0.012Ω.

The concept described above may also be adopted in a nominal Φ 128 alternator, as well as in the nominal Φ 139 alternator. Alternators with their outer diameters in a range of Φ 128 to Φ 139 are normally referred to as nominal Φ 128 alternators. The losses, the efficiency and the stator coil resistance value of the nominal Φ 128 alternator (output: 140 A) are indicated in the “Φ 128 ALT” column in FIG. 33.

The data provided in the nominal Φ 139 ALT column and the nominal Φ 128 ALT column in FIGS. 32 and 33 pertain to alternators each equipped with a stator having 12 poles. While an alternator is typically equipped with a stator having 16 poles, the alternators achieved in the embodiments are 12-pole alternators. While a 12-pole alternator is bound to manifest a higher level of ohmic loss due to a greater number of turns compared to a 16-pole alternator, the frequency at the 12-pole alternator at a given rotation rate is lower than the frequency at the 16-pole alternator. This means that the frequency-dependent iron loss can be further reduced. Moreover, the number of turns at the 12-pole alternator can be minimized by adopting a dispersal winding structure, as described later, and the stator ohmic loss can thus be reduced. In other words, by adopting a dispersal winding structure in the stator coil of the 12-pole alternator, losses that are not dependent upon the frequency (i.e., the stator ohmic loss, the rectification loss, the mechanical loss, the field ohmic loss) can be controlled to substantially match those of a 16-pole alternator and, at the same time, the frequency-dependent iron loss can be reduced relative to that of the 16-pole alternator. Consequently, an even more efficient alternator can be provided since the sum of the stator ohmic loss and the iron loss is reduced.

The double star connection is adopted in the nominal Φ 128 alternator in FIG. 33 as well. 76% efficiency or better can be achieved for this alternator by setting the stator ohmic loss to 140 W or less or by setting the resistance value for a single-phase coil to 0.022Ω or less.

The data presented in FIG. 33 can be interpreted as follows. Namely, by ensuring that the sum of the stator ohmic loss and the iron loss (including the eddy current loss occurring on the stator side) does not exceed the sum of the rectification loss, the mechanical loss and the field ohmic loss, 76% efficiency or better can be achieved. As an alternative, the sum of the stator ohmic loss and the iron loss may be set equal to or less than a predetermined value so as to assure the required efficiency of 76% or better.

If a 16 pole structure is adopted in the nominal Φ 128 alternator, the ohmic loss can be reduced due to the smaller number of turns. However, the iron loss is bound to increase. Through deliberation of these factors, it has been learned that efficiency of 76% or better can be achieved by ensuring that the sum of the stator ohmic loss and the iron loss never exceeds 150 Win the nominal Φ 128 alternator with 16 poles. The various types of losses in the nominal Φ 128 alternator with 16 poles are indicated in FIG. 35. The stator resistance is set by ensuring that the sum of the stator ohmic loss and the iron loss does not exceed 150 W.

In addition, MOSFETs or neodymium magnets may be used in the nominal Φ 128 alternator, as in the nominal Φ 139 alternator, to further improve its efficiency. The individual types of losses in the nominal Φ 128 alternator equipped with MOSFETs and neodymium magnets are indicated in the “Φ 128 (MOSFET+neodymium)” column in FIG. 33.

The following stator winding structures may be adopted in order to achieve resistance values or stator ohmic losses meeting the requirements described above.

A vehicular AC generator, which includes a stator and a rotor each constituted with a winding and a iron core, generates power with a magnetomotive force induced at a coil wound at the stator as the rotor, magnetized with a DC current supplied to the winding wound at the rotor or with permanent magnets disposed at the rotor, rotates and a rotating magnetic field is thus formed at the stator.

A stator coil in a generator may be wound around teeth constituting magnetic poles of the stator by adopting a distributed winding structure or a concentrated winding structure. While the stator coil adopting a distributed winding structure may be wound through full pitch winding or short pitch winding, in either case the coil is wound substantially over 180° in electric angle and is then wound in the opposite direction over the remaining 180° in either case. Coils corresponding to all the phases are wound around the teeth of the stator. In the distributed winding structure, a magnetic flux induced with an electrical current flowing through a coil creates complete interlinkage at the particular coil. In other words, a magnetic flux induced in correspondence to a given coil turn achieves interlinkage with an adjacent same-phase coil turn. This means that the inductance at the coil is bound to be relatively large. The relatively large coil inductance is bound to result in a smaller electrical current generated in a generator or it may manifest as a poor coil current control response in a motor.

In the concentrated winding structure, on the other hand, completely separate coils, each corresponding to a specific phase, are wound at the teeth independently of one another. The strength of the magnetic flux from the rotor received at each coil is bound to be approximately “1/number of phases” in the 360° electric angle range. For instance, the magnetic flux received at each coil in a three-phase AC system will be approximately ⅓ in the 360° electric angle range. For this reason, the coil must be wound with a greater number of turns in order to increase the interlinking magnetic flux strength, which, in turn, increases the coil inductance. As a result, problems similar to those of the distributed winding structure are bound to occur in the concentrated winding structure. Namely, only a small electrical current will be generated in a generator or the coil current control response in a motor is bound to be compromised.

There is another issue to be addressed in the concentrated winding structure in that a significant higher harmonic component in electromagnetic forces caused by an armature reaction attributable to the electrical current flowing through the stator coil manifests as relatively significant noise during rotation. A sixth-order time higher harmonic component, which is one of the primary causes of noise, can be canceled out via two three-phase systems set with a phase difference Ø of approximately 30°. Since the phase difference Ø assumed in the related art described earlier is 60°, the sixth-order time higher harmonic component, i.e., one of the primary causes of noise, cannot be reduced readily.

In addition, since the related art described earlier is achieved fundamentally by adopting the concentrated winding structure, only the part of the interlinking magnetic flux provided from the rotor, which corresponds to a 120° electric angle range, can be utilized in conjunction with the stator coil corresponding to a given phase in a generator. In other words, while the interlinking magnetic flux is utilized over the 360° electric angle range in the distributed winding structure, the interlinking magnetic flux is only partially utilized in the three-phase concentrated winding system.

Each of the following embodiments through which the ohmic loss can be kept down by minimizing the size of a coil return located at a stator end, improves the efficiency with which a rotating electrical machine operates.

In addition, since the higher harmonic component in electromagnetic force can be reduced relative to that in the concentrated winding structure, noise reduction can be achieved through the following embodiments.

Furthermore, in the embodiments to be described below, the self-inductance at a coil in a system through which a matching induced voltage is obtained, i.e., in a system assuming a mutual inductance equal to that on the rotor side, can be lowered relative to the coil self-inductance in the distributed winding structure or the concentrated winding structure. The coil self-inductance in the embodiments can be kept down since, unlike the coil wound over the full range in the distributed winding structure, the coil corresponding to each phase in the embodiments is allocated with only part of the 360° electric angle range and thus, only part of the interlinking magnetic flux generated at the coil itself interlinks with the coil. Moreover, a stator coil and a rotor magnetic pole in the concentrated winding structure face opposite each other over an area amounting to only half the area over which the stator coil and the rotor magnetic pole face opposite each other in the present invention. Thus, the number of coil turns in the concentrated winding structure must be greater in order to assure a higher level of induced voltage. Since the coil inductance increases exponentially with the number of coil turns, the coil inductance is bound to increase in this situation. Since the coil self-inductance can be kept low in any of the following embodiments, better coil current control characteristics are assured when the present invention is adopted in a motor, and improved power generation characteristics are achieved when it is adopted in a generator.

In addition, in the following embodiments adopted in vehicular AC generators operated in a wide rotation rate range, from a low rotation rate of 2000 rpm or lower through a high rotation rate of 15,000 rpm or higher, very good electrical characteristics are assured in the full rotation rate range. A vehicular AC generator generates electric power based upon rotational energy in an internal combustion engine that drives the vehicle. The extremely wide rotation rate range through which such a vehicular AC generator is utilized gives rise to an issue in that the impedance attributable to the stator coil inductance is bound to increase in the high rotation rate range, to result in a reduced output current. Such a decrease in the output current may lead to lowered efficiency as well. Through the embodiments described below, it is ensured that the stator coil inductance does not increase readily and thus, the current output characteristics in the high rotation rate range are improved.

While an explanation has been given so far on improvements achieved from the viewpoint of electrical performance, problems other than those discussed above can be solved and advantages other than those described above can be achieved through the following embodiments. Any of the embodiments described below, adopted in a vehicular AC generator with fewer turns at the stator winding can be manufactured with improved productivity. Namely, it is an essential requirement for a vehicular AC generator, which is to be installed in a vehicle, that it be provided as a compact unit. In the embodiments described below, a smaller number of turns is assumed at the stator and thus, better productivity is assured even when the stator is manufactured as a more compact unit. Furthermore, since the stator assumes a smaller number of turns compared to stators in the related art, the need for miniaturization can be more easily met.

Through the embodiments to be described below, superior productivity or a high level of reliability is assured since the number of connecting points in the stator winding is kept down. More specifically, a vehicular AC generator is likely to be operated in an environment where vibration of the body or vibration of the internal combustion engine is transmitted readily. In addition, it is likely to be operated in an environment where the temperature changes drastically from below 0 to very high temperatures. For these reasons, it is desirable to minimize the number of connecting points such as welding areas. Since the following embodiments assure fewer coil turns and a greater area where the coil is exposed, heat trapping or the like that would readily occur as coils are buried under other coils can be avoided, and thus, superior heat resistance characteristics are achieved. In this sense, too, the embodiments described below can be adopted in vehicular AC generators in an ideal manner.

### Embodiment 1

FIG. 1 is a conceptual diagram of the vehicular AC generator achieved in embodiment 1, with a rotor 1 and a stator 2 constituting part of the AC generator shown in a linearly expanded view. The rotor 1 includes a plurality of rotor magnetic poles 11. At the stator 2, facing opposite the rotor 1 via an air gap, a plurality of teeth 21, which form magnetic poles of the stator 2, are formed. A U-phase coil 31, a V-phase coil 32 and a W-phase coil 33 are wound around the plurality of teeth 21. In the description, the “V-phase coil” is defined as a coil through which an AC current flows with the phase thereof retarded by 120° (advanced by 240°) relative to the phase of the AC current flowing through the U-phase coil. The “W-phase coil” is defined as a coil through which an AC current flows with the phase thereof retarded by 240° (advanced by 120°) relative to the phase of the AC current flowing through the U-phase coil.

A solid line indicates a coil wound forward (wound along the clockwise direction around the teeth viewed from the inner circumferential side), whereas a dotted line indicates a coil wound along the reverse direction (wound along the counterclockwise direction around the teeth viewed from the inner circumferential side). While FIG. 1 shows a forward-wound coil assuming a position further away from the rotor, a forward wound coil may instead take up a position closer to the rotor. As shown in FIG. 1, the stator coil structure in the embodiment is a double coil structure with two concentrated coil windings set with an offset by 180° in electric angle relative to each other, with the U-phase coils, the V-phase coils and the W-phase coils each connected in series.

In other words, the stator 2 is disposed so as to form an air gap between the stator 2 and the rotor 1, the coils are wound so that two stator magnetic poles 91 and 92 are formed with coil turns corresponding to a given phase within the 360° electric angle range, the angular widths assumed by the coil turns, which form the stator magnetic poles 91 and 92, along the circumferential direction, are each smaller than 180° in electric angle, the coil turns forming the two stator magnetic poles 91 and 92 are set by ensuring that they do not overlap each other, and the stator magnetic poles 91 and 92 in each stator magnetic pole pair assume opposite polarities in this rotating electrical machine.

The coil turns forming the two stator magnetic poles 91 and 92 in the rotating electrical machine are shifted relative to each other by 180° in electric angle. Stator magnetic poles formed in correspondence to the three phases U, V and W are shifted relative to one another by 60° in electric angle. It is to be noted that the V-phase coils are wound along the direction opposite from the direction in which the U-phase coils are wound. As a result, the phase of the V-phase coils is retarded by +60°−180°=−120°. Namely, the phase of the V-phase coils is retarded by 120° relative to the phase of the U-phase coils. In addition, the phase of the W-phase coils, wound along the direction matching the direction in which the U-phase coils are wound, is advanced by 2×60°=120° relative to the phase of the U-phase coils. Furthermore, each coil turn ranges over 120° width in electric angle and the two coil turns corresponding to a given phase together amount to a total angular width of 240°, i.e., teeth accounting for ⅔ of all the teeth. In the following description, this coil winding method will be referred to as a “dispersal winding” structure.

The individual coil turns in the stator coil achieved in the embodiment as described above interlink with the magnetic flux from the rotor over a circuit area twice as large as that achieved in a concentrated winding structure with a single concentrated winding coil disposed within the 360° electric angle range and, as a result, the stator coil in the embodiment assures coil utilization efficiency twice that of the concentrated winding structure. In other words, an interlinking magnetic flux, the intensity of which matches that of the interlinking magnetic flux achieved in the concentrated winding structure, can be obtained through the embodiment with the number of coil turns at any given tooth reduced to half the number of corresponding coil turns in the concentrated winding structure. The U-phase coils, the V-phase coils and the W-phase coils in the winding structure are each present over a range twice as large as the coil range of the concentrated winding structure and the coils corresponding to each phase is wound at teeth accounting for ⅔ of all the teeth, unlike the coils in the distributed winding structure, which are wound at all the teeth. This means that a lower coil inductance is achieved compared to the coil inductances in the concentrated winding structure and the distributed winding structure.

In addition, since the winding structure in the embodiment allows the coils to be present over a range twice as large as that in the concentrated winding structure and the U-phase coils, the V-phase coils and the W-phase coils are wound with an overlap, the extent of which is equivalent to approximately half a turn. As a result, the armature reaction can be distributed along the circumferential direction relatively smoothly compared to the armature reaction distribution in the concentrated winding structure, which, in turn, leads to a reduction in the higher harmonic component attributable to higher-order electromagnetic forces. This allows the vehicular AC generator to function as a quieter rotating electrical machine compared to a rotating electrical machine adopting the concentrated winding structure.

It is to be noted that while one stator tooth is set every 60° in electric angle and the coils are wound with each coil turn assuming a width equivalent to 120° in electric angle in the example presented in FIG. 1, advantages similar to those of the embodiment can also be achieved by disposing a stator tooth every 30° in electric angle and winding the coils with each coil turn assuming an angular width of 90°, 120° or 150° in electric angle. In addition, while a stator tooth is disposed every 60° in electric angle and the coils are wound with each coil turn assuming a width equivalent to 120° in electric angle in the embodiments adopting a single three-phase system to be described below in reference to FIGS. 2 through 9, advantages similar to those of the embodiments, too, can be achieved by disposing a stator tooth every 30° in electric angle and winding the coils with each coil turn assuming an angular width of 90°, 120° or 150° in electric angle.

### Embodiment 2

FIG. 2 is a conceptual diagram pertaining to the vehicular AC generator achieved in embodiment 2. Apart from the features described below, which distinguish embodiment 2 from embodiment 1, embodiment 2 is identical to embodiment 1 described earlier.

The present embodiment includes stator coils wound differently from the coils in embodiment 1. The stator coils are each wound at teeth 21 over two layers, to range from a position in a slot closer to the rotor over to a position further away from the rotor. The coils are wound so as to assure uniformity for all the coils with regard to their positions assumed along the radial direction. Namely, one of the two slots insertion portions that each coil turn includes is set in a slot at a position closer to the rotor and the other slot insertion portion is set in a slot at a position further away from the rotor, so as to assure consistency among the coil inductances corresponding to the individual phases. While uniformity is achieved with regard to the coil positions assumed at the teeth 21 along the radial direction by serially connecting the coils corresponding to the individual phases in embodiment 1, uniformity is assured for all the coils that are not serially connected. The schematic diagram presented in FIG. 27 illustrates this concept. Coils each present over a range accounting for ⅓ of a full cycle are set in sequence in circulation so that all the coils are dispersed evenly over the entire cycle.

An even distribution of coils corresponding to the individual phases at the teeth 21 along the radial direction is highly desirable, since it facilitates configuration of a stable three-phase AC system.

### Embodiment 3

FIG. 3, in reference to which embodiment 3 is to be described below, shows how coils may be wound in a rotating electrical machine. FIG. 3 presents a view of a stator 2 disposed further outside relative to the rotor 1, seen from the inner side along the radial direction, with a U-phase coil 31, a V-phase coil 32 and a W-phase coil 33 respectively shown at the top, the middle and the bottom. In order to clearly illustrate how the coils are wound, the coils are shown as lines without substantial thickness in FIG. 3. The lateral direction assumed in the drawing is equivalent to the direction extending along the circumference of the stator 2. In this example, six slots (six teeth) are present in correspondence to every 360° in electric angle. This means that there is a phase difference of 60° in electric angle between each two consecutive slots (teeth).

The U-phase coil 31, the V-phase coil 32 and the W-phase coil 33 in FIG. 3 are identically wound. Accordingly, the following description is given in reference to a single phase. The coil is wound by two turns so as to achieve a circumferential angular width of 120° in electric angle (wound over two teeth 21 in this example), thereby forming one stator magnetic pole 91. The direction along which the coil is wound around at this time will be referred to as the forward winding direction. Then, the coil is inserted through a slot set apart by 180° in electric angle (equivalent to three teeth 21) from the slot at which the coil has been most recently inserted at the magnetic pole 91, and the coil is then wound by two turns from the new slot along the direction opposite from the direction of the coil turns constituting the stator magnetic pole 91, thereby forming a stator magnetic pole 92. The direction along which the coil is wound to form the stator magnetic pole 92 will be referred to as the reverse winding direction. When the coil is wound with two turns, as in this case, the coil is inserted twice in each of the two slots through which the coil is wound. A forward winding stator magnetic pole 91 and a reverse winding stator magnetic pole 92 are formed alternately to each other in this manner. These stator magnetic poles 91 and 92, formed with a single coil wire, are connected in series. Through these measures, the entire coil length can be minimized, which will greatly reduce the ohmic loss.

It is to be noted that the coils corresponding to the three phases are wound by ensuring that equal numbers of coil segments are inserted in the individual slots formed between the plurality of teeth 21. By ensuring that a uniform number of coil segments are inserted in each slot, an even coil distribution is achieved. Since the coils do not need to concentrate in any particular spot, they can be wound with better ease and the coils can be uniformly cooled with cooling air. It will be obvious that the dispersal winding structure achieved in the embodiment may be adopted in conjunction with coils inserted in varying numbers at different slots, as well.

A total of four coil segments are inserted through each slot in embodiment 3. It is to be noted that the present embodiment can be adopted in applications in which an even number of coil segments are inserted through each slot.

### Embodiment 4

FIG. 4 shows how the coils are wound in the vehicular AC generator achieved in embodiment 4. Apart from the features described below, embodiment 4 is identical to embodiment 3. In the drawing, a U-phase coil 31, a V-phase coil 32 and a W-phase coil 33 are respectively shown at the top, the middle and the bottom.

While a magnetic pole is formed with two coil turns in embodiment 3 described above, each magnetic pole is formed with the coil turned 2.5 times in embodiment 4. Namely, the coil is wound by 2.5 turns so as to achieve a circumferential angular width of 120° in electric angle (would over two teeth 21 in this example), thereby forming a first stator magnetic pole 91. Then, the coil is inserted through a slot set apart by 180° in electric angle (equivalent to three teeth 21) from the slot at which the coil has been most recently inserted at the first magnetic pole 91, and the coil is subsequently wound by 2.5 turns from the new slot along the direction opposite from the direction of the coil turns constituting the stator magnetic pole 91, thereby forming a stator magnetic pole 92. When the coil is wound with 2.5 turns, as in this case, the coil is inserted twice through one of the two slots at which the coil is housed and the coil is inserted three times through the other slot. In embodiment 4, the coil ends of the coils corresponding to all the phases can be disposed evenly on both sides and thus, the coil ends do not become excessively large. While the coils are wound with 2.5 turns in this example, the present embodiment may be adopted in conjunction with coils wound with turns made up with full turns and a half turn.

It is to be noted that a total of five coil segments are inserted through each slot in embodiment 4. The present embodiment can be adopted in applications in which an odd number of coil segments are inserted through each slot.

### Embodiment 5

FIG. 5 shows how the coils are wound in the vehicular AC generator achieved in embodiment 5. Apart from the features described below, embodiment 5 is identical to the preceding embodiments. In the drawing, a U-phase coil 31, a V-phase coil 32 and a W-phase coil 33 are respectively shown at the top, the middle and the bottom. The arrows marking the coils in FIG. 5 indicate the directions along which the electrical currents flow through the two coil systems in each phase at a given time point.

While the forward winding coil (stator magnetic pole 91) and the reverse winding coil (stator magnetic pole 92) are formed with a single coil wire in embodiments 3 and 4 described above, the forward winding coil and the reverse winding coil in embodiment 5 are constituted with separate coil wires. Namely, the U-phase coil 31 is constituted with a forward winding coil 311 and a reverse winding coil 312, the V-phase coil 32 is constituted with a forward winding coil 321 and a reverse winding coil 322 and the W-phase coil 33 is constituted with a forward winding coil 331 and a reverse winding coil 332. It is to be noted that the U-phase coil 31, the V-phase coil 32 and the W-phase coil 33 are all wound in manners similar to one another.

A first stator magnetic pole 91 wound in the forward direction is formed by winding a coil so as to assume an angular width of 120° (over two teeth 21 in this example) in electric angle along the circumferential direction. Next, the coil is inserted through a slot set apart by 240° in electric angle (equivalent to four teeth 21) from the slot at which the coil has been most recently inserted in correspondence to the first magnetic pole 91, and the coil is then wound by two turns from the new slot along the direction matching the direction of the coil turns constituting the stator magnetic pole 91, thereby forming a second stator magnetic pole 91. Subsequently, all the remaining stator magnetic poles 91 are formed as described above.

Likewise, a first stator magnetic pole 92 wound in the reverse direction is formed by winding a coil along a direction opposite from the direction in which the coil is wound to form the stator magnetic poles 91 so as to range astride an angular width of 120° (over two teeth 21 in this example) in electric angle along the circumferential direction within a 240° range in electric angle surpassed by the forward winding coil, with a 180° shifting relative to the phase of the stator magnetic poles 91. Next, the coil is inserted through a slot set apart by 240° in electric angle (equivalent to four teeth 21) from the slot at which the coil has been most recently inserted in correspondence to the first magnetic pole 92, and the coil is then wound from the new slot along the direction matching the direction of the coil turns constituting the first stator magnetic pole 92, thereby forming a second stator magnetic pole 92. Subsequently, all the remaining stator magnetic poles 92 are formed as described above.

It is desirable that the forward winding coil and the reverse winding coil be connected in series. By connecting the forward winding coil and the reverse winding coil, the coil ends of all the coils corresponding to each phase can be set evenly on both sides so as to prevent the coil ends from becoming excessively large, so as to facilitate the coil winding process and thus assure better mass productivity.

It is to be noted that a total of four coil segments are inserted through each slot in embodiment 5. The present embodiment can be adopted in applications in which an even number of coil segments are inserted through each slot.

### Embodiment 6

FIG. 6 shows how the coils are wound in the vehicular AC generator achieved in embodiment 6. Apart from the features described below, embodiment 6 is identical to the preceding embodiments. In the drawing, a U-phase coil 31, a V-phase coil 32 and a W-phase coil 33 are respectively shown at the top, the middle and the bottom. The arrows marking the coils in FIG. 6 indicate the directions along which the electrical currents flow through the two coil systems in each phase at a given time point.

In addition to the structural features of embodiment 5 shown in FIG. 5, embodiment 6 includes third coils indicated with the dotted lines, i.e., a U-phase coil 313, a V-phase coil 323 and a W-phase coil 333. These coils are each wound alternately through a slot housing a forward winding coil turn and a slot housing a reverse winding coil turn in a wave winding with a phase difference of 180° in electric angle. This may be considered a hybrid structure achieved by combining the dispersal winding structure and the distributed winding structure, with which the higher harmonic reducing characteristics, i.e., the distinct advantage of the distributed winding structure, can be somewhat enhanced.

It is to be noted that a total of five coil segments are inserted through each slot in embodiment 6. The present embodiment can be adopted in applications in which an odd number of coil segments are inserted through each slot.

### Embodiment 7

FIG. 7 shows how the coils are wound in the vehicular AC generator achieved in embodiment 7. Apart from the features described below, embodiment 7 is identical to the preceding embodiments. In the drawing, a U-phase coil 31, a V-phase coil 32 and a W-phase coil 33 are respectively shown at the top, the middle and the bottom. The arrows marking the coils in FIG. 7 indicate the directions along which the electrical currents flow through the two coil systems in each phase at a given time point.

The winding structure in embodiment 7, too, includes forward winding coils and reverse winding coils that are independent of each other. A forward winding stator magnetic pole 91 is formed by winding two coils in a wave winding so as to assume an angular width of 120° in electric angle (over two teeth 21 in this example) along the circumferential direction. The coils are then inserted through a slot set apart by 240° in electric angle (by four teeth 21 in this example) from the slot where the coils have been most recently inserted, and the two coils are wound in a wave winding so that the two coils extend from the slot in a direction matching the direction of the coil turn constituting the stator magnetic pole 91.

Likewise, a reverse winding stator magnetic pole 92 is formed with two coils wound in a reverse wave winding so as to assume an angular width of 120° in electric angle along the circumferential direction with a phase of the two coils shifted by 180° relative to the phase of the forward winding stator magnetic pole 91 within a 240° electric angle range surpassed by the forward winding coils. Next, the two coils are inserted through a slot set apart by 240° in electric angle (by four teeth 21 in the example) and the two coils are wound in a reverse wave winding so that they extend from the slot with an angular width of 120° in electric angle along the circumferential direction. The coils are repeatedly wound as described above so as to form reverse winding stator magnetic poles 92. While the two coils may be connected to each other in parallel or in series, it is desirable that the forward winding coils and the reverse winding coils be connected in series. Through these measures, coil ends of the coils corresponding to all the phases can be disposed evenly on both sides and thus, coil ends do not become excessively large. In addition, the wave winding pattern adopted in the embodiment allows the coils to be wound with better ease and thus, outstanding mass productivity is assured.

It is to be noted that a total of four coil segments are inserted through each slot in embodiment 7. The present embodiment can be adopted in applications in which an even number of coil segments are inserted through each slot.

### Embodiment 8

FIG. 8 shows how the coils are wound in the vehicular AC generator achieved in embodiment 8. Apart from the features described below, embodiment 8 is identical to the preceding embodiments. The arrows marking the coils in FIG. 8 indicate the directions along which the electrical currents flow through the two coil systems in each phase at a given time point.

In addition to the structural features of embodiment 7 shown in FIG. 7, embodiment 8 includes third coils, i.e., a U-phase coil 313, a V-phase coil 323 and a W-phase coil 333. These coils are each wound alternately through a slot housing a forward winding coil turn and a slot housing a reverse winding coil turn in a wave winding with a phase difference of 180° in electric angle. This may be considered a hybrid structure achieved by combining the dispersal winding structure and the distributed winding structure, with which the higher harmonic reducing characteristics, i.e., the distinct advantage of the distributed winding structure, can be somewhat enhanced.

It is to be noted that a total of five coil segments are inserted through each slot in embodiment 8. The present embodiment can be adopted in applications in which an odd number of coil segments are inserted through each slot.

### Embodiment 9

FIG. 9 shows how the coils are wound in the vehicular AC generator achieved in embodiment 9. Apart from the features described below, embodiment 9 is identical to the preceding embodiments. The arrows marking the coils in FIG. 9 indicate the directions along which the electrical currents flow through the two coil systems in each phase at a given time point.

Embodiment 9 is achieved by modifying embodiment 7 shown in FIG. 7. The coils constituting the stator magnetic poles 92 are shifted by 180° in electric angle (by three teeth 21 in the example) relative to the coils constituting the stator magnetic poles 91, and an electrical current flows through the coils constituting the stator magnetic poles 92 along a direction opposite from the direction in which an electrical current flows through the coils constituting the stator magnetic poles 91. As a result, the two teeth 21 corresponding to each magnetic pole can be encircled by a loop current.

It is to be noted that a total of four coil segments are inserted through each slot in embodiment 9. The present embodiment can be adopted in applications in which an even number of coil segments are inserted through each slot.

### Embodiment 10

FIG. 10 is a diagram illustrating the concept based upon which coils are wound in the vehicular AC generator achieved in embodiment 10. Structural features of embodiment 10 apart from those described below are similar to those of the embodiments described above.

The embodiment features a structure achieved by combining the dispersal winding structure described above and a double three-phase structure. Namely, two winding assemblies, each wound as shown in FIG. 1, are disposed by shifting their phases relative to each other. In addition, twelve teeth 21 are disposed over a 360° electric angle range with a phase difference of 30° in electric angle assumed between each two consecutive teeth 21. At the teeth 21, a three-phase AC system coil (three-phase system A) adopting the dispersal winding structure is disposed further outward along the radial direction and a three-phase AC system coil (three-phase system B) adopting the dispersal winding structure is disposed further inward along the radial direction. The three-phase system B, disposed at a position shifted by 30° in electric angle relative to the three-phase system A, is connected in parallel. The coils in the three-phase systems A and B are each wound so as to bundle, for instance, four teeth at a time.

### Embodiment 11

FIG. 11 is a diagram illustrating the concept based upon which coils are wound in the vehicular AC generator achieved in embodiment 11. Structural features of embodiment 11 apart from those described below are similar to those of the embodiments described above.

Embodiment 11 also features a winding assembly constituting a three-phase system A and a winding assembly constituting a three-phase system B. It is desirable that the winding assembly in the three-phase system A and the winding assembly in the three-phase system B be electric circuit elements equivalent to each other. By constituting the winding assemblies with electric circuit elements equivalent to each other, the higher harmonics in the electromagnetic forces can be effectively reduced and since uniform currents can be output from the generator, ripples in the combined output current can be minimized.

Accordingly, coils to be wound along the circumferential direction are oriented diagonally with an offset along the radial direction, as shown in FIG. 11. Namely, the winding assembly in the three-phase system A and the winding assembly in the three-phase system B each form stator magnetic poles in three phases. The windings corresponding to a given phase, which are shifted by 30° in electric angle relative to each other, are wound through slots that are next to each other, and their coil ends are each inserted either at a position in a slot closer to or further away from the rotor, so as to ensure that the coil ends never cross each other. Through these measures, two three-phase systems A and B, assuring equivalent electric circuit characteristics, are achieved.

While FIG. 11 shows a structural example in which four teeth are wound together with each coil turn over a 120° range in electric angle along the circumferential direction, three teeth may be wound together, as shown in FIG. 12, over a 90° range in electric angle along the circumferential direction as an alternative. As a further alternative, five teeth may be wound together, as shown in FIG. 13, over a 150° range in electric angle along the circumferential direction.

By adopting the dispersal winding structure in a double three-phase system and setting a phase difference between the two three-phase systems A and B at 30° or close to 30° in electric angle, as in this embodiment, a sixth-order time higher harmonic component related to the electromagnetic force can be effectively reduced and thus, the noise of the generator can be significantly reduced.

### Embodiment 12

FIG. 14 is a diagram illustrating the concept based upon which coils are wound in the vehicular AC generator achieved in embodiment 12. Structural features of embodiment 12 apart from those described below are similar to those of the embodiments described above. While a double three-phase system structure is achieved by doubling the quantity of teeth in the example presented in FIG. 11, a double three-phase system structure is achieved through the present embodiment while keeping the quantity of teeth per magnetic pole at the rotor down to three.

FIG. 14 illustrates how such a double three-phase system structure may be achieved. The basic dispersal winding structure is partially modified in this example. The U-phase forward winding coil in the three-phase system A, which is indicated by the solid line in FIG. 14, is wound so as to range astride three teeth, whereas the U-phase reverse winding coil, indicated by the dotted line, is wound so as to range astride two teeth. The U-phase forward winding coil in the three-phase system B, which is indicated by the solid line, is wound so as to range astride two teeth, whereas the U-phase reverse winding coil, indicated by the dotted line, is wound so as to range astride three teeth. In either system, the forward winding coil and the reverse winding coil are wound through the same slots and the slots are shared by the three-phase system A and the three-phase system B.

FIG. 15 presents U-phase coil winding diagrams. FIG. 15(a) shows the U-phase coils in the three-phase system A, whereas FIG. 15(b) shows the U-phase coils in the three-phase system B. As FIG. 15 illustrates, a forward winding coil 314 and a reverse winding coil 315 in the three-phase system A and a forward winding coil 317 and a reverse winding coil 316 in the three-phase system B are each wound in a wave winding pattern. The forward winding coils and the reverse winding coils are wound with equal numbers of turns. The phasor diagram presented in FIG. 16 indicates the quantities of magnetic flux picked up via the U-phase coils wound by adopting this structure. The phasor diagram is drawn by factoring in the phase difference. The numerical values 6 and 2 in the figure indicate the relative quantity of phasors of magnetic flux corresponding to the forward winding coils and the reverse winding coils wound with two coil turns. Through vector calculation, the phasor phase difference with respect to the quantities of magnetic fluxes picked up via the U-phase coils in the three-phase system A and the three-phase system B is determined to be 27.8° in electric angle. While the phase difference does not exactly match 30°, the corresponding sixth-order time higher harmonic component in electromagnetic excitation force reduction rate is calculated to be; (1+cos(6×27.8°))/2=0.013, i.e., 1.3%, proving that a much quieter generator is achieved through a full noise reduction effect.

As described above, in each three-phase coil system constituted with U-phase coils, V-phase coils and W-phase coils, the forward winding coil and the reverse winding coil corresponding to each phase are wound over different numbers of teeth. Since the quantity of teeth does not need to be doubled, the coils can be wound with better ease in the present embodiment.

If the two three-phase systems are set with shifting of 20° relative to each other, the sixth-order time higher harmonic component in electromagnetic excitation force can be reduced by 25% ((1+cos(6×20°))/2=0.25), and if they are shifted by 40° relative to each other, the sixth-order time higher harmonic component in electromagnetic excitation force can also be reduced by 25% ((1+cos(6×40°))/2=0.25). This means that as long as the two three-phase systems are disposed shifting in the 20 through 40° range, the sixth-order time higher harmonic component in electromagnetic excitation force can be reduced by 25% or better.

### Embodiment 13

FIGS. 17 through 19 illustrate embodiment 13. Embodiment 13, achieved based upon a concept similar to that of embodiment 12 described above, includes auxiliary coils added to the structure shown in FIG. 15. FIG. 17 is a conceptual diagram indicating the concept based upon which the coils are wound, FIG. 18 shows specifically how the coils are wound and FIG. 19 is a phasor diagram similar to that presented in FIG. 16. As shown in FIG. 18, the coils are all wound by adopting a wave winding pattern. In this case, too, the sixth-order time higher harmonic excitation force component is reduced by a rate equal to that achieved in the preceding embodiment and thus, advantages similar to those of embodiment 12 are achieved.

### Embodiment 14

FIGS. 20 through 22 illustrate embodiment 14. FIG. 20 is a conceptual diagram indicating the concept based upon which the coils are wound, FIG. 21 shows specifically how the coils are wound in FIG. 22 is a phasor diagram. As shown in FIG. 21, the coils are all wound by adopting a wave winding pattern. In this case, too, the sixth-order time higher harmonic excitation force component is reduced by a rate equal to that achieved in the preceding embodiment ((1+cos(6×32.2°))/2=0.013) and thus, advantages similar to those of the previous embodiment are achieved.

### Embodiment 15

FIG. 23 is a conceptual diagram illustrating how coils are disposed in embodiment 15. By slightly shifting the coil positions assumed in the three-phase system A and the coil positions assumed in the three-phase system B relative to each other, a phase difference closer to 30° in electric angle can be achieved for the three-phase system A and the three-phase system B. As the phasor diagram presented in FIG. 24 indicates, a phase difference of; 43.9−16.1=27.8° in electric angle is achieved in this embodiment for the three-phase system A and the three-phase system B relative to each other. In this case, too, the sixth-order time higher harmonic excitation force component is reduced by a rate equal to that achieved in the preceding embodiment ((1+cos(6×27.8°))/2=0.013) and thus, advantages similar to those of the previous embodiment are achieved. The positional arrangement assumed in conjunction with the coils in FIG. 23 is a conceptual arrangement and it will be obvious that the coils may be displaced along the radial direction to facilitate the winding process without compromising the sixth-order time higher harmonic component in electromagnetic excitation force reducing effect.

Any of the embodiments described above may be adopted in a rotating electrical machine such as a motor or a generator used in a wide range of applications, including electrical power machine applications, industrial applications, home appliance applications and automotive applications. Any of the embodiments of the present invention may be successfully adopted in diverse fields of application as large-scale rotating electrical machine units such as wind-power generators, automotive drive sources, power generating rotating electrical machines and industrial rotating electrical machines, as medium-scale rotating electrical machines including industrial units and auxiliary units in automobiles, and as small rotating electrical machine units used in home appliances, office equipment and the like.

The present invention may be adopted in a generator, as described in reference to the following embodiments. By assuming the double three-phase system structure described above, a desirable electrical current can be generated with minimum ripple.

FIG. 25 is a sectional view of an air-cooled vehicular AC generator 100 achieved in an embodiment of the present invention. A rotor 1 includes claw poles 113 formed at the center of a shaft and a field winding 112 disposed at the center of the claw poles 113. A pulley 101 is attached to the front end of the shaft, with a slip ring 109, through which power is fed to the field winding, disposed on the opposite side. In addition, a front fan 107F and a rear fan 107R, constituting a cooling fan that rotates in synchronization with the rotation of the rotor, are disposed each at one of the two sides where end surfaces of the claw poles 113 of the rotor 1 are present. Permanent magnets 116 are disposed at the claw poles 113 so as to fulfill an auxiliary excitation function in order to increase the field winding electromagnetic flux. A stator 2, constituted with stator magnetic poles 91 and 92 and a stator winding, is disposed so as to face opposite the rotor across a slight gap. The stator 2 is held by a front bracket 114 and a rear bracket 115, and the two brackets and the rotor 1 are rotatably supported by bearings 102F and 102R. Power is fed as the slip ring 109 mentioned earlier comes into contact with a brush 108. The stator winding is constituted with three-phase windings, as has been described in reference to the embodiments, and lead wires of the individual windings are connected to a rectifier circuit 111. The rectifier circuit 111, constituted with rectifier elements such as diodes, is a full wave rectifier circuit. The cathode terminal of a diode constituting the rectifier circuit is connected to a terminal 106, whereas an anode-side terminal is electrically connected to the body of the vehicular AC generator itself. A rear cover 110 protects the rectifier circuit 111.

Next, the power generation operation is described. An engine (not shown) and the vehicular AC generator 100 are normally linked with each other via a belt. The pulley 101 at the vehicular AC generator 100 is connected to the engine side through the belt, and the rotor 1 rotates together with the engine. As an electrical current flows through the field winding 112 disposed at the center of the claw poles 113 at the rotor 1, the claw poles 113 become magnetized. As the rotor 1 rotates in this state, a three-phase induced electromotive force is generated at the stator winding. The voltage of the electromotive force thus generated undergoes full wave rectification at the rectifier circuit 111 mentioned earlier and thus, a DC voltage is generated. The positive side of the DC voltage is connected to the terminal 106 and is further connected to a battery (not shown). Although a detailed description is not provided, the field current is controlled so as to ensure that the DC voltage resulting from the rectification achieves a level optimal for battery charge.

FIG. 26 shows three-phase rectifier circuits that may be achieved by using the windings shown in FIG. 25. FIG. 26(a) corresponds to the embodiments shown in FIGS. 1 through 9, whereas FIG. 26(b) corresponds to the embodiments shown in FIG. 10 and subsequent drawings. The windings corresponding to the individual phases are connected through a three-phase Y connection. The terminals of the three-phase coils located on the anti-neutral point side are connected to six diodes D1+ through D3−, as shown in the figures. In addition, the cathodes located on the positive side of the diodes are connected as a common cathode to the positive side of the battery. Likewise, the anodes located at the negative-side terminals of the diodes are all connected to a negative terminal of the battery.

In FIG. 26(b), the voltages at a U1 winding and a U2 winding in the three-phase winding assemblies, which are electrically independent of each other, are equal but their electrical phases are shifted by 30° relative to each other. For this reason, an area with higher potential is selectively used and ultimately, a ripple having a 30° width manifests.

It is to be noted that while a star connection is adopted in the examples described above, the present invention may be adopted in conjunction with a Δ connection. The A connection is more advantageous in that the coil induced voltage can be raised by 11.5% over the voltage induced in the star connection.

It is to be noted that the present invention having been described above in reference to the various embodiments may be summarized as follows. Namely, it may be embodied as a generator comprising a stator that includes stator coils through which electrical currents in a single three-phase AC system flow, teeth, around which the stator coils are wound and a core back that induces reflux of a magnetic flux flowing through the teeth, and a rotor that includes magnetic poles facing opposite the teeth. Stator coils wound at a given tooth in the stator are a U-phase coil and a V-phase coil alone, a V-phase coil and a W-phase coil alone or a W-phase coil and a U-phase coil alone.

In addition, the present invention may be embodied as a generator comprising a stator that includes stator coils through which electrical currents in a single three-phase AC system flow, teeth, around which the stator coils are wound and a core back that induces a reflux of a magnetic flux flowing through the teeth, and a rotor that includes magnetic poles facing opposite the teeth. In the generator, a concentrated winding coil system constituted with a U-phase coil, a V-phase coil and a W-phase coil is disposed at the teeth at a position further outward along the radial direction, a concentrated winding coil system constituted with a U-phase coil, a V-phase coil and a W-phase coil wound along a direction opposite from the direction in which the coils are wound in the first concentrated winding coil system is disposed at the teeth at a position further inward along the radial direction, and coils corresponding to each phase in the two concentrated winding coil systems are connected in series.

Furthermore, it may be embodied as a generator that includes two three-phase coil systems each made up with a U-phase coil, a V-phase coil and a W-phase coil, with the two coil systems disposed with a phase difference equivalent to approximately 30° in electric angle or an angle within a range of 20° through 40° in electric angle.

While the circuits shown in FIG. 26 include diodes functioning as rectifier elements, a synchronous rectifier circuit achieved by using MOSFETs instead of diodes may assume a circuit structure such as that shown in FIG. 28. The circuit shown in FIG. 28 includes a stator coil Y1 with a single star connection similar to that shown in FIG. 26(a), with MOSFETs 401a, 402a, 403a, 401b, 402b and 403b, disposed in place of the diodes D1+, D2+′ D3+, D1−, D2− and D3− in FIG. 26(a). A MOS control circuit 404 enables a rectification operation by controlling the on-off states of the individual MOSFETs 401a through 403b, in correspondence to whether the U-phase, the V-phase and W-phase voltages are positive or negative.

The modifications made in the winding structure as described earlier are not the sole measures for lowering the resistance at a stator coil for purposes of reducing the ohmic loss. Namely, the stator coil resistance can be effectively reduced by increasing the coil sectional area within the slots. FIGS. 29 and 30 each present an example of such an alternative measure.

In the example presented in FIG. 29, the stator coil resistance is reduced by increasing the slot sectional area. FIG. 29 shows part of a stator core 500 in a sectional view. The left half of FIG. 29 shows the core before the improvement is made, whereas the right half of FIG. 29 shows the core resulting from the improvement. At the stator core 500, a tooth 501 and a slot 502 are formed so as to take up alternate positions along the circumferential direction. A stator coil (not shown), housed within the slots 502, is wound around from a given tooth 501 to another tooth 501. The slots 502 in the improved structure shown on the right side are enlarged toward the core back, as indicated by the arrow and, as a result, the sectional area of the slots 502 is increased by an area A2 over the pre-improvement area A1. Since this allows the sectional area of the stator coil to be increased as well, the coil resistance and the ohmic loss can both be reduced.

In the second example presented in FIG. 30, the coil installation efficiency is improved by allowing a coil wire with a larger wire diameter to be housed in a slot 602 adopting a semi-closed structure with a semi-closed coil insertion opening. FIG. 30(b) shows a stator coil 603 housed within the slot 602 in a sectional view. In conjunction with the semi-closed slot, projections (hereafter referred to as projecting portions) 601a, each projecting along the circumferential direction, are formed at the front ends of teeth 601 and the slot opening is thus narrowed with the projecting portions. In the semi-closed slot structures in the related art, this limits the types of coil wires that can be used to wires with diameters smaller than the opening width H.

At a stator core 600 shown in FIG. 30, projecting portions 601a are formed at the front ends of the teeth 601 without blocking the opening, as shown in FIG. 30(a), allowing the slot opening to assume a width substantially equal to the width inside the slot 602. By forming the projecting portions in this shape, the use of a coil wire with a coil diameter substantially equal to the slot width is enabled. In this example, a rectangular coil wire is used so as to maximize the coil sectional area. It is to be noted that such a rectangular wire does not need to have a perfectly rectangular section but may have rounded corners. In addition, reference numeral 604 indicates an insulating material such as insulating paper.

Once the coil 603 is inserted into the slot 602, as shown in FIG. 30(a), the front ends of the teeth can be altered so as to achieve a substantially T-shape by caulking or swaging the projecting portions 601, as indicated by the arrows in FIG. 30(b). As a result, a shape similar to that assumed in conjunction with the semi-open slot structure in the related art is achieved. This structure allows the use of a coil wire with a larger wire diameter, which, in turn, makes it possible to reduce the stator coil resistance.

The embodiments described above may be adopted singularly or in combination to realize a singular advantage or combined advantages. In addition, as long as the features characterizing the present invention are not compromised, the present invention is not limited to any of the specific structural particulars described herein, in reference to the embodiments.

1. A vehicular AC generator, comprising:
a rotor with a plurality of magnetic poles, assuming a shape for suppressing bias magnetism, and disposed along a circumferential direction, which includes a field winding;
a stator disposed so as to leave a gap between the rotor and the stator; and
a semiconductor element that rectifies an AC current induced at a stator coil wound at the stator as power is supplied to the field winding at the rotor so as to convert the AC current to a DC current, wherein:
the stator is formed by laminating electromagnetic steel plates; and
a resistance value of the stator coil wound at the stator is set to a value equal to or less than a predetermined value.

2. A vehicular AC generator according to claim 1, wherein:
the semiconductor element is constituted with a diode;
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a double star connection and a coil resistance value at the stator coil corresponding to one phase is equal to or less than 0.018Ω when an ambient temperature is 20° C. to 25° C.

3. A vehicular AC generator according to claim 1, wherein:
the semiconductor element is constituted with a diode;
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a single star connection and a coil resistance value at the stator coil corresponding to one phase is equal to or less than 0.009Ω when an ambient temperature is 20° C. to 25° C.

4. A vehicular AC generator according to claim 1, wherein:
the semiconductor element is constituted with a MOSFET;
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a double star connection and a coil resistance value at the stator coil corresponding to one phase is equal to or less than 0.018Ω when an ambient temperature is 20° C. to 25° C.

5. A vehicular AC generator according to claim 4, wherein:
a magnet constituted of neodymium is disposed between claw poles at the rotor; and
the stator coil is connected through a double star connection and a coil resistance value at the stator coil corresponding to one phase is equal to or less than 0.012Ω when an ambient temperature is 20° C. to 25° C.

6. A vehicular AC generator according to claim 1, wherein:
the semiconductor element is constituted with a MOSFET;
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a single star connection and a coil resistance value at the stator coil corresponding to one phase is equal to or less than 0.009Ω when an ambient temperature is 20° C. to 25° C.

7. A vehicular AC generator according to claim 6, wherein:
a magnet constituted of neodymium is disposed between claw poles at the rotor; and
the stator coil is connected through a single star connection and a coil resistance value at the stator coil corresponding to one phase is equal to or less than 0.006Ω when an ambient temperature is 20° C. to 25° C.

8. A vehicular AC generator according to claim 1, wherein:
the semiconductor element is constituted with a MOSFET;
the stator, which assumes a diameter equivalent to a diameter of a stator in a nominal Φ 128 vehicular AC generator is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a double star connection and a coil resistance value at the stator coil corresponding to one phase is equal to or less than 0.022Ω when an ambient temperature is 20° C. to 25° C.

9. A vehicular AC generator according to claim 8, wherein:
a magnet constituted of neodymium is disposed between claw poles at the rotor; and
the stator coil is connected through a double star connection and a coil resistance value at the stator coil corresponding to one phase is equal to or less than 0.015Ω when an ambient temperature is 20° C. to 25° C.

10. A vehicular AC generator according to claim 1, wherein:
the semiconductor element is constituted with a MOSFET;
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator coil is connected through a single star connection and a coil resistance value at the stator coil corresponding to one phase is equal to or less than 0.011Ω when an ambient temperature is 20° C. to 25° C.

11. A vehicular AC generator according to claim 10, wherein:
a magnet constituted of neodymium is disposed between claw poles at the rotor; and
the stator coil is connected through a single star connection and a coil resistance value at the stator coil corresponding to one phase is equal to or less than 0.0075Ω when an ambient temperature is 20° C. to 25° C.

12. A vehicular AC generator, comprising:
a rotor with a plurality of magnetic poles, assuming a shape for suppressing bias magnetism and disposed along a circumferential direction, which includes a field winding;
a stator disposed so as to leave a gap between the rotor and the stator; and
a semiconductor element that rectifies an AC current induced at a stator coil wound at the stator as power is supplied to the field winding at the rotor so as to convert the AC current to a DC current, wherein:
the stator is formed by laminating electromagnetic steel plates; and
a stator ohmic loss manifesting under a half load is equal to or less than a predetermined value.

13. A vehicular AC generator according to claim 12, wherein:
a remaining loss value, representing a remainder calculated by subtracting a rectification loss occurring at the semiconductor element under the half load, a mechanical loss defined as a loss in a no-load/non-magnetized state, an iron loss under a half load at a predetermined rotation rate, which includes an eddy current loss occurring at the rotor, and a field ohmic loss under the half load at the predetermined rotation rate, from a loss expected to occur in the generator under the half load while assuring required efficiency, is set to the predetermined value.

14. A vehicular AC generator according to claim 13, wherein:
the stator, which assumes a diameter equivalent to a diameter of a stator with a nominal Φ 139 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator ohmic loss occurring at a coil temperature of approximately 80° C. is equal to or less than 185 W.

15. A vehicular AC generator according to claim 13, wherein:
a number of poles is 12;
the stator, which assumes a diameter equivalent to a diameter of a stator with a nominal Φ 128 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
the stator ohmic loss occurring at a coil temperature of approximately 80° C. is equal to or less than 140 W.

16. A vehicular AC generator according to claim 13, wherein:
a number of poles is 16;
the stator, which assumes a diameter equivalent to a diameter of a stator with a nominal Φ 128 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
a sum of the stator ohmic loss and the iron loss at a coil temperature of approximately 80° C. is equal to or less than 150 W.

17. A vehicular AC generator according to claim 13, wherein:
the stator, which assumes a diameter equivalent to a diameter of a stator with a nominal Φ 139 vehicular AC generator, is formed by laminating electromagnetic steel plates having a thickness of 0.35 mm and manifests a loss of 2 to 3 W/kg or less when a rotational frequency is 50 Hz and a magnetic flux density is 1.5 T; and
the stator ohmic loss is less than a sum of the rectification loss, the mechanical loss and the field ohmic loss.

18. A vehicular AC generator according to claim 13, wherein:
the stator, which assumes a diameter equivalent to the diameter of a stator with a nominal Φ 128 vehicular AC generator, is formed by laminating electromagnetic steel plates having a thickness of 0.35 mm and manifesting a loss of 2 to 3 W/kg or less when a rotational frequency is 50 Hz and a magnetic flux density is 1.5 T; and
a sum of the stator ohmic loss and the iron loss is less than a sum of the rectification loss, the mechanical loss and the field ohmic loss.

19. A vehicular AC generator, comprising:
a rotor with a plurality of magnetic poles, assuming a shape for suppressing bias magnetism and disposed along a circumferential direction, which includes a field winding;
a stator disposed so as to leave a gap between the rotor and the stator and assuming a diameter equivalent to a diameter of a stator in a nominal Φ 139 vehicular AC generator; and
a diode that rectifies an AC current induced at a stator coil wound at the stator as power is supplied to the field winding at the rotor so as to convert the AC current to a DC current, wherein:
the stator is formed by laminating electromagnetic steel plates; and
a stator ohmic loss is less than a sum of a rectification loss occurring at the diode, a mechanical loss and a field ohmic loss.

20. A vehicular AC generator, comprising:
a rotor with a plurality of magnetic poles, assuming a shape for suppressing bias magnetism and disposed along a circumferential direction, which includes a field winding;
a stator disposed so as to leave a gap between the rotor and the stator and assuming a diameter equivalent to a diameter of a stator in a nominal Φ 128 vehicular AC generator; and
a diode that rectifies an AC current induced at a stator coil wound at the stator as power is supplied to the field winding at the rotor so as to convert the AC current to a DC current, wherein:
the stator is formed by laminating electromagnetic steel plates; and
a sum of a stator ohmic loss and an iron loss is less than a sum of a rectification loss occurring at the diode, a mechanical loss and a field ohmic loss.

21. A vehicular AC generator according to claim 19, wherein:
the stator is formed by laminating electromagnetic steel plates with a thickness of 0.35 mm, which manifest a loss of 2 to 3 W/kg when a rotational frequency is 50 Hz and a magnetic flux density is 1.5 T.

22. A vehicular AC generator, comprising:
a rotor with a plurality of magnetic poles, assuming a shape for suppressing bias magnetism and disposed along a circumferential direction, which includes a field winding;
a stator disposed so as to leave a gap between the rotor and the stator; and
a diode that rectifies an AC current induced at a stator coil wound at the stator as power is supplied to the field winding at the rotor, so as to convert the AC current to a DC current, wherein:
the stator is formed by laminating electromagnetic steel plates with a thickness of 0.35 mm, which manifest a loss of 2 to 3 W/kg when a rotational frequency is 50 Hz and a magnetic flux density is 1.5 T; and
a sum of a stator ohmic loss and iron loss is set equal to or less than a predetermined value so as to ensure that power generation efficiency of at least 76% is achieved under a half load.

23. A vehicular AC generator, comprising:
a rotor with a plurality of magnetic poles, assuming a shape for suppressing bias magnetism and disposed along a circumferential direction, which includes a field winding;
a stator disposed so as to leave a gap between the rotor and the stator; and
a MOSFET that rectifies an AC current induced at a stator coil wound at the stator as power is supplied to the field winding at the rotor, so as to convert the AC current to a DC current, wherein:
the stator is formed by laminating electromagnetic steel plates with a thickness of 0.35 mm, which manifest a loss of 2 to 3 W/kg when a rotational frequency is 50 Hz and a magnetic flux density is 1.5 T; and
a sum of a stator ohmic loss and iron loss is set equal to or less than a predetermined value so as to ensure that power generation efficiency of at least 86% is achieved under a half load.

24. A vehicular AC generator according to claim 1, wherein:
grooves are formed at the magnetic poles of the rotor in order to reduce an eddy current.

25. A vehicular AC generator according to claim 2, wherein:
the diode is a Schottky diode.

26. A vehicular AC generator according to claim 1, wherein:
a coil constituted with a round wire is wound at the stator.

27. A vehicular AC generator according to claim 1, wherein:
a coil constituted with a rectangular wire is wound at the stator.

28. A vehicular AC generator according to claim 1, wherein:
the stator coil is wound at the stator so as to form two stator magnetic poles with coil turns corresponding to a given phase and a stator core within a 360° in electric angle range assumed by the magnetic poles at the rotor, the coil turns forming the stator magnetic poles each assume an angular width along a circumferential direction which is smaller than 180° in electric angle, the coil turns forming the two stator magnetic poles are set without an overlap with each other, and the coil turns are wound so as to allow two stator magnetic poles next to each other to assume opposite polarities.
